(19) United States
(12) Patent Application Publication
(10) Pub. No.: US 2006/0105179 A1
(43) Pub. Date: May 18, 2006

(54) Elastomeric dental article with a protective fluoropolymer layer

(76) Inventors: Gerald Rainer Adalbert Hofman, Oakdale, MN (US); Naiyong Jing, Woodbury, MN (US); Tsi-Zong Tzou, Arcadia, CA (US); Mark W. Muggli, West St. Paul, MN (US)

Correspondence Address: 3M INNOVATIVE PROPERTIES COMPANY, PO BOX 33427, ST. PAUL, MN, 55133-3427, US

(21) Appl. No.: 10/991,235

(22) Filed: Nov. 17, 2004

(51) Int. Cl. B32B 27/40

(52) U.S. Cl. 428/423.1

(57) ABSTRACT

Protective fluoropolymer layers for dental articles, particularly orthodontic appliances, that include an elastomeric substrate, are provided that reduce adhesion of materials such as food stains, bacteria and proteinaceous substances to these surfaces, which can cause staining. Methods of reducing adhesion of these materials to such surfaces are also provided.

### BACKGROUND

Materials used in the oral environment, such as orthodontic appliances, are susceptible to discoloration. Such discoloration, i.e., staining, can result from dietary chromagens and/or the formation of plaque. This is particularly true for dental articles that include an elastomeric material.

Various types of elastomeric devices are used in orthodontic treatment. These are often referred to as force modules. For example, tiny O-ring devices are used as ligatures to secure the arch wire in slots of the brackets. Also, elongated devices, including chain-like modules having a number of interconnected O-ring portions, may be stretched between selected brackets in order to move certain teeth relative to other teeth. Other devices that include elastomeric materials are especially adapted to separate adjacent teeth or to rotate a tooth about its long axis.

Current elastomeric materials for orthodontic force modules are polyester- or polyether-based polyurethanes, such as poly(ethyleneadipate)urethane, available from Bayer Corporation under the trade designation TEXIN or polyether-based polyurethane, available from Dow under the trade designation PELLETHANE. These materials have good mechanical properties (including tear strength, elongation, and tensile strength), biocompatibility in the human body, and are clear or in different colors when new. They typically present a satisfactory appearance when first installed in the mouth next to metallic or ceramic brackets and metallic archwires. However, conventional elastomeric devices quickly stain when exposed to foods or beverages such as mustard, tea, and coffee. Mustard, in particular, has been known as a stain agent that is difficult to resist. Brushing the teeth or rinsing the mouth normally does not remove the stain, and the unsightly appearance persists until the devices are replaced. Discoloration is particularly noticeable when the brackets are made of translucent ceramic and assume the color of the underlying tooth.

U.S. Pat. No. 4,933,418 (Sterrett) indicates that a particular crosslinked polyurethane orthodontic device made using polycaprolactone is more resistant to staining by mustard than devices made of other mentioned materials. However, there is a continuing need in the art to provide elastomeric orthodontic devices that are more resistant to staining than the devices known in the past, in order to improve the appearance of the device in the mouth as much as feasible. Elastomeric orthodontic devices should also permit substantial elongation before rupture, be resistant to tearing, and provide satisfactory resistance to force degradation over extended periods of time.

New materials have been considered for such devices. For example, low surface energy elastomeric materials, such as fluoroelastomers or silicones, are stain resistant. Although U.S. Pat. No. 5,461,133 (Hammar et al.) and U.S. Pat. No. 5,317,074 (Hammar et al.) describe stain-resistant elastomeric force modules made of different classes of materials (e.g., polyurethane, polyurea, polyurethane/polyurea, fluoroelastomer, silicone, and blends thereof), stain-resistant coatings are not disclosed.

Known surface modification methods of orthodontic force modules with polyurethane elastomeric surfaces can involve treatment by ion implantation (F or Ar) or plasma deposition (O₂/CF₄, Ar, CF₄/CH₄, CF₄, CH₄ or C₂F₆/CH₄) to improve stain resistance and reduce protein adsorption, as indicated in U.S. Pat. No. 5,378,146.

Coatings have been used to reduce such staining hard tissues or surfaces of the oral environment, including dental articles; however, the challenge in stain-resistant coatings is that the material has to adhere to the elastomeric substrate and not crack or flake off. This is especially difficult when, for example, elastomericic force modules are stretched during installation and throughout treatment. An additional challenge is that the coating has to be durable enough to withstand toothbrushing.

Known coating compositions and methods include coating with a fluorine-containing copolymer. For example, U.S. Pat. No. 5,662,887 (Rozzi et al.) discloses coating orthodontic appliances with a copolymer having repeating units of A, B, and C where monomer A is 1-80 wt-% of a polar or polarized group (e.g., acrylic acid), B is 0-98 wt-% of a modulating group (e.g., isobutyl methacrylate and methyl methacrylate) and C is 1-40 wt-% of hydrophobic fluorine-containing groups. Coatings containing a polysiloxane-containing copolymer are also known, as disclosed in U.S. Pat. No. 5,876,208 (Mitra et al.). However, these coatings were on hard tissue and surfaces, not on elastomers.

There is still a need for stain-resistant coatings, particularly those that can strongly and uniformly adhere to elastomeric materials, without flaking or delamination even when the force modules are stretched and abraded.

The discussion of prior publications and other prior knowledge does not constitute an admission that such material was published, known, or part of the common general knowledge.

### SUMMARY

The present invention provides dental articles, particularly orthodontic appliances (e.g., force modules such as ligatures and chains), that include an elastomeric substrate and a protective fluoropolymer-containing layer thereon. Such protective layers reduce adhesion of materials such as dietary chromagens, bacteria, and proteinaceous substances, for example, to these surfaces, which can cause staining. Methods of reducing adhesion of these materials to such surfaces are also provided.

In one embodiment, the present invention provides a dental article that includes an elastomeric substrate having disposed thereon at least one layer that includes a fluoropolymer derived from at least one monomer selected from the group consisting of vinylidine fluoride, vinyl fluoride, hexafluoropropylene, tetrafluoroethylene, hexafluoropropylene oxide, a perfluoroalkylvinyl ether, and combinations thereof.

Besides these fluoropolymers, the present invention provides dental articles that include elastomeric substrates coated with other fluoropolymers. Such fluoropolymers preferably include at least 30 wt-% fluorine. Thus, in another embodiment of the present invention, there is provided a dental article that includes an elastomeric substrate having disposed thereon at least one layer that includes a fluoropolymer having at least 30 wt-% fluorine.

Suitable fluoropolymers can be perfluorinated (i.e., a perfluoropolymer) or partially fluorinated. Suitable fluoropolymers can be homopolymers or copolymers (i.e., polymers prepared from two or more different monomers, which includes terpolymers, tetrapolymers, etc.). Preferably, the fluoropolymer is a copolymer. In certain embodiments, the fluoropolymer-containing layer includes a mixture of two or more fluoropolymers.

In certain embodiments, the fluoropolymer is selected from the group consisting of tetrafluoroethylene/hexafluoropropylene/vinylidene fluoride terpolymer, polyvinylidene fluoride, vinylidene fluoride/hexafluoropropylene copolymer, vinylidene fluoride/tetrafluoroethylene copolymer, polytetrafluoroethylene, ethylene/tetrafluoroethylene copolymer, tetrafluoroethylene/hexafluoropropylene copolymer, propylene/tetrafluoroethylene copolymer, ethylene/tetrafluoroethylene/hexafluoropropylene terpolymer, and mixtures thereof.

Preferably, the fluoropolymer is selected from the group consisting of tetrafluoroethylene/hexafluoropropylene/vinylidene fluoride terpolymer, polyvinylidene fluoride, vinylidene fluoride/hexafluoropropylene copolymer, vinylidene fluoride/tetrafluoroethylene copolymer, polytetrafluoroethylene, ethylene/tetrafluoroethylene copolymer, tetrafluoroethylene/hexafluoropropylene copolymer, and mixtures thereof.

The fluoropolymer-containing layer can include a mixture (e.g., blend) of fluoropolymers or a mixture of one or more fluoropolymers with one or more nonfluorinated polymers. The nonfluorinated polymer can be of a wide variety, and is preferably selected from the group consisting of acrylic polymers (e.g., polymethyl methacrylate (PMMA)), urethane polymers, vinyl acetate copolymers, and combinations thereof.

The present invention also provides methods of reducing adhesion of materials such as food stains, bacteria and proteinacious substances to a dental article. The methods include: providing a dental article including an elastomeric substrate; and depositing at least one layer comprising a fluoropolymer to at least a portion of the elastomeric substrate. In one embodiment, the fluoropolymer is derived from at least one monomer selected from the group consisting of vinylidine fluoride, vinyl fluoride, hexafluoropropylene, tetrafluoroethylene, hexafluoropropylene oxide, a perfluoroalkylvinyl ether, and combinations thereof. In another embodiment, the fluoropolymer comprises at least 30 wt-% fluorine.

In yet another embodiment, the present invention provides an elastomeric substrate (which may or may not be in the form of, or form a part of, a dental article) including an organic polymeric material (e.g., polyurethane) having disposed thereon at least one layer comprising a fluoropolymer, wherein the fluoropolymer is prepared from a halogen-containing fluoropolymer and a peroxide curing system (e.g., including an organic peroxide initiator and a multifunctional aliphatic unsaturated compound).

### DEFINITIONS

“Elastomer” or “elastomeric material” means a natural or synthetic polymer which at room temperature can be repeatedly stretched to at least twice its original length and which, after removal of the tensile stress, will quickly and forcibly return to approximately its original length. “Force modules” are orthodontic elastomeric devices that are used to move a tooth or an orthodontic appliance relative to other teeth or orthodontic appliances due to the resilient force of the device in tension or compression.

The terms “comprises” and variations thereof do not have a limiting meaning where these terms appear in the description and claims.

The terms “a,” “an,” “the,” “at least one,” and “one or more” are used interchangeably.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

### BRIEF DESCRIPTION OF THE DRAWINGS

FIG. 1 is a side elevational view of an orthodontic ligature device that is made in accordance with one embodiment of the invention.

FIG. 2 is a side elevational view of a ligature device according to another embodiment of the invention.

FIG. 3 is a side elevational view of a chain-like device made in accordance with another embodiment of the invention.

FIG. 4 is a side elevational view of an elongated device made in accordance with yet another embodiment of the invention.

FIG. 5 is a perspective view of an orthodontic rotation wedge device according to another embodiment of the invention.

FIG. 6 is a graph of coating thickness relative to coating solution concentration on a PELLETHANE substrate.

FIG. 7 is a graph of coating thickness relative to coating solution concentration on a TEXIN substrate.

### DETAILED DESCRIPTION OF ILLUSTRATIVE EMBODIMENTS

Dental articles, particularly orthodontic appliances, which include an elastomeric substrate, can be very difficult to coat with a protective material. The present invention provides a fluorine-containing polymeric material that adheres well to elastomeric materials that form a part of a dental material, particularly an orthodontic device. In other words, the polymeric materials provided in accordance with the invention are highly substantive to elastomeric surfaces. The protective materials have high resistance to food stains, plaque, bacteria, and the like, as compared to dental materials that do not contain the protective fluoropolymeric material thereon.

The fluoropolymers are provided in an amount sufficient to provide resistance of the underlying surface to bacterial adhesion, plaque formation, or staining from foods or dyes. The fluoropolymer may be provided as a continuous or semi-continuous layer. Preferably, the fluoropolymer is applied in an amount at least sufficient to provide a substantially continuous monolayer of polymer as described herein on the underlying surface. The protective coating may be in the form of one or more layers, which may be of the same or different fluoropolymers.

Other advantages may also be realized through the use of the fluoropolymer materials of the present invention. In particular, a stain-resistant fluoropolymer used on orthodontic force modules may result in reduced friction and accelerated tooth movement. Another benefit may be reduced biofilm formation on orthodontic force modules and hence less enamel decalcification, since the fluoropolymer layer with a low surface energy that repels stains is likely to inhibit the attachment of bacteria. Yet another benefit may be that the inert low energy surface protects the elastomeric material from biodegradation.

Dental articles that include an elastomeric material can be protected with a fluoropolymer as discussed herein. Such articles include orthodontic force modules (e.g., ligatures, chains, dogbone-shaped force modules, rotation wedges, interarch modules, elastic thread, and separators), retainers, tooth positioners, relatively flexible tooth alignment trays, and mouthguards. Preferred dental articles of the present invention include orthodontic ligatures, chains, and dogbone-shaped force modules used in tension.

Such elastomeric dental articles typically include a polyurethane, nitrile rubber, ethylene propylene diene monomer (EPDM) rubber, styrenic block copolymers (e.g., styrene-butadiene-styrene, styrene-ethylene/butadiene-styrene and styrene-isoprene), or combinations thereof. Examples of other materials used in elastomeric dental articles are disclosed, for example, in U.S. Pat. No. 5,317,074 (Hammar et al.). Examples of elastomeric orthodontic force modules (e.g., ligatures, chains, and dogbone-shaped force modules) include a polyester-based urethane or a polyether-based urethane. Current elastomeric materials for orthodontic force modules are polyester- or polyether-based polyurethanes, such as poly(ethyleneadipate)urethane, available from Bayer Corporation under the trade designation TEXIN or polyether-based polyurethane, available from Dow under the trade designation PELLETHANE.

Typically, current elastomeric dental articles, particularly orthodontic force modules, find particular advantage when coated with a fluoropolymer as discussed herein. For force modules, the force exerted and the ability to be stretched without breakage are important physical properties. Typically, the material of the device can be stretched without breakage to at least 150% elongation, and often to at least 400% elongation. Thus, protective layers on such elastomeric devices need to adhere under such conditions.

Many fluoropolymers have been largely unexplored as fluoropolymer coatings on organic substrates. This is due in part to the fact that: (a) polytetrafluoroethylene (PTFE) and related fluoropolymers have no solubility in common organic solvents; (b) they have a reputation of being nonadherent to other substrates (thus providing poor durability and mechanical properties of the coatings); and (c) most fluoroelastomers require curing after application using curing chemistries that may shorten the shelf life of a coating composition in solution form and may not be suitable for use in medical applications due to toxicology concerns.

Suitable fluoropolymers may be a perfluorinated polymer or a partially fluorinated polymer.

Suitable fluoropolymers are those having a molecular weight of at least 10,000. Preferably, the fluoropolymers include at least 30 wt-% fluorine.

In certain embodiments, at least 50% of the fluorine atoms present in the polymer are in the backbone of the polymer. In certain embodiments, at least 75% of the fluorine atoms present in the polymer are in the backbone of the polymer. In certain embodiments, substantially all the fluorine atoms are in the backbone of the polymer. In certain embodiments, at least 50% of the fluorine atoms present in the polymer are in the side chains of the polymer. In certain embodiments, at least 75% of the fluorine atoms present in the polymer are in the side chains of the polymer. In certain embodiments, substantially all the fluorine atoms are in the side chains of the polymer. Examples of such fluoropolymers are disclosed in U.S. Pat. No. 5,662,887 (Rozzi et al.). The side chains can also be perfluoropolyethers or perfluoroalkyl compounds.

As used herein, the longest continuous chain in a molecule represents the backbone. Groups attached to the backbone are called substituents or side chains.

Examples of suitable fluoropolymers are those derived from at least one monomer selected from the group consisting of vinylidine fluoride, vinyl fluoride, hexafluoropropylene, tetrafluoroethylene, hexafluoropropylene oxide, a perfluoroalkylvinyl ether (e.g., perfluoromethylvinyl ether and perfluoropropylvinyl ether), and combinations thereof. These can be homopolymers (e.g., polytetrafluoroethylene or poly(vinylidene fluoride)) or copolymers (e.g., copolymers of tetrafluoroethylene and hexafluoropropylene). Other monomers, particularly ethylenically unsaturated monomers, which may or may not be fluorinated (such as, ethylene or chlorotrifluoroethylene monomers), can be used in combination with these monomers as long as the polymer is derived from at least one of the listed monomers. Preferably, the fluoropolymer includes interpolymerized units derived from vinylidene fluoride, vinyl fluoride, hexafluoropropylene, tetrafluoroethylene, hexafluoropropylene oxide, a perfluoroalkylvinyl ether, and combinations thereof.

Examples of suitable fluoropolymers include tetrafluoroethylene/hexafluoropropylene/vinylidene fluoride terpolymers (THV), tetrafluoroethylene/hexafluoropropene copolymer (FEP), polyvinylidene fluoride, vinylidene fluoride/hexafluoropropylene copolymers, polytetrafluoroethylene (PTFE), ethylene/tetrafluoroethylene copolymer (commercially available as TEFZEL and TEFLON ETFE from DuPont), vinylidene fluoride/tetrafluoroethylene copolymer, propylene/tetrafluoroethylene copolymer, ethylene/tetrafluoroethylene/hexafluoropropylene terpolymer, and mixtures thereof.

Examples of preferred fluoropolymers include tetrafluoroethylene/hexafluoropropylene/vinylidene fluoride terpolymers (THV), tetrafluoroethylene/hexafluoropropene copolymer (FEP), polyvinylidene fluoride, vinylidene fluoride/hexafluoropropylene copolymers, polytetrafluoroethylene (PTFE), ethylene/tetrafluoroethylene copolymer (commercially available as TEFZEL and TEFLON ETFE from DuPont), vinylidene fluoride/tetrafluoroethylene copolymer, and mixtures thereof.

The fluoropolymer may or may not be melt-processable (e.g., thermoplastic). Melt-processable polymers include, for example, a terpolymer of tetrafluoroethylene, hexafluoropropylene, and vinylidene fluoride (THV) and a copolymer of tetrafluoroethylene and hexafluoropropene (FEP). Non-melt processable polymers include, for example, polytetrafluoroethylene (PTFE), modified PTFE copolymers, such as a copolymer of TFE and low levels of fluorinated vinyl ethers, and fluoroelastomers.

Preferred fluoropolymer materials useful in the present invention include copolymers (including terpolymers, etc.) with interpolymerized units derived from vinylidene fluoride (sometimes referred to as “VF₂” or “VDF”). Preferably fluoropolymer materials of this preferred class include at least 3 percent by weight (wt-%) of interpolymerized units derived from VF₂. Such polymers may be homopolymers of VF₂ or copolymers (including terpolymers) of VF₂ and other ethylenically unsaturated monomers. A particularly preferred such polymer includes interpolymerized units derived from vinylidene fluoride and hexafluoropropylene.

VF₂-containing homopolymers and copolymers can be made by well-known conventional means, for example by free-radical polymerization of VF₂ with or without other ethylenically unsaturated monomers. The preparation of colloidal aqueous dispersions of such polymers and copolymers is described, for example, in U.S. Pat. No. 4,335,238 (Moore et al.). Other methods of preparing VF₂-containing fluoropolymer using emulsion polymerization techniques are described in U.S. Pat. No. 4,338,237 (Sulzbach et al.) or U.S. Pat. No.5,285,002 (Grootaert).

Other fluorinated polymers useful in the practice of the invention include homopolymers and copolymers (including terpolymers, etc.) that include interpolymerized units derived from one or more of hexafluoropropylene (“HFP”) monomers, tetrafluoroethylene (“TFE”) monomers, chlorotrifluoroethylene monomers, and/or other perhalogenated monomers and further derived from one or more hydrogen-containing and/or non-fluorinated olefinically unsaturated monomers.

Useful fluorine-containing monomers include hexafluoropropylene (“HFP”), tetrafluoroethylene (“TFE”), chlorotrifluoroethylene (“CTFE”), 2-chloropentafluoropropene, perfluoroalkyl vinyl ethers (e.g., CF₃OCF═CF₂ or CF₃CF₂OCF═CF₂), 1-hydropentafluoropropene, 2-hydro-pentafluoropropene, dichlorodifluoroethylene, trifluoroethylene, 1,1-dichlorofluoroethylene, vinyl fluoride, and perfluoro-1,3-dioxoles, such as those described in U.S. Pat. No. 4,558,141 (Squire). Certain fluorine-containing di-olefins also are useful, such as perfluorodiallylether and perfluoro-1,3-butadiene.

Fluorine-containing monomers also may be copolymerized with fluorine-free (preferably terminally unsaturated) olefinic comonomers, e.g., ethylene or propylene. Preferably at least 50% by weight of all monomers in a polymerizable mixture are fluorine-containing. Useful olefinically unsaturated monomers include alkylene monomers such as ethylene and propylene.

Fluorine-containing monomers may also be copolymerized with iodine-, chlorine-, cyano-, or bromine-containing cure-site monomers (particularly halogen-containing cure-site monomers) in order to prepare peroxide curable polymers. Suitable cure-site monomers include terminally unsaturated monoolefins of 2 to 4 carbon atoms such as bromodifluoroethylene, bromotrifluoroethylene, iodotrifluoroethylene, and 4-bromo-3,3,4,4-tetrafluorobutene-1,4-cyanoperfluorobutyl vinyl ether (CF₂═CFOCF₂CF₂CF₂CF₂CN). An example of a halogen-containing fluoropolymer E-15742 is a terpolymer of TFE/HFP/VDF with brominated cure site monomer. Such halogen-containing fluoropolymers can be cured with a peroxide curing system.

Fluoropolymers of the present invention can be prepared by methods known in the fluoropolymer art. Such methods include, for example, free-radical polymerization of hexafluoropropylene and/or tetrafluoroethylene monomers with nonfluorinated ethylenically unsaturated monomers. In general, the desired olefinic monomers can be copolymerized in an aqueous colloidal dispersion in the presence of water-soluble initiators which produce free radicals such as ammonium or alkali metal persulfates or alkali metal permanganates, and in the presence of emulsifiers such as the ammonium or alkali metal salts of perfluorooctanoic acid. See, for example, U.S. Pat. No. 4,335,238 (Moore et al.).

Suitable materials are also commercially available. These include, for example, those commercially available under the trade designations THV (terpolymers of CF₂═CF₂/CH₂═CF₂/CF₃CF═CF₂ (TFE/VDF/HFP) available from Dyneon LLC of Saint Paul, Minn.), KYNAR (VDF homopolymers and VDF copolymers available from Atofina), FLUOREL (e.g., a copolymer of CF₂═CH₂/CF₃CF═CF₂ (VDF/HFP) available from Dyneon LLC), and fluoropolymers sold under the trade designation VITON by DuPont. Other useful fluoropolymer materials also are available commercially, for example, from Dyneon LLC under the trade designations HOSTAFLON; from Daikin America, Inc., under the trade designations NEOFLON; from Asahi Glass Co. under the trade designations AFLON COP; and from DuPont under the trade designations TEFZEL.

Other useful fluoropolymers include fluorosilicones and fluoroalkoxyphosphazenes, as long as they have a sufficient amount of fluorine (e.g., at least 30 wt-%) to provide desirable results. Although certain embodiments can include silicon-containing fluoropolymers, others preferably include less than 5 wt-% silicon atoms, more preferably less than 3 wt-% silicon atoms, and even more preferably substantially no silicon atoms.

The above-described fluoropolymers may be mixed (e.g., blended) with one another or with another fluorinated or nonfluorinated polymer to form a composite material useful to construct a fluorinated layer. Polyvinylidene fluoride, for example, may be blended with polymethylmethacrylate (PMMA). For example, as can be seen in Table 16, in certain situations, ligatures coated with blends of KYNAR and PMMA polymers showed very good stain test results.

Optionally, the fluoropolymer can be mixed (e.g., blended) with the same material as that of the elastomeric substrate, such as polyurethane. Examples of nonfluorinated polymers are those selected from the group consisting of acrylic polymers, urethane polymers, vinyl acetate copolymers, and combinations thereof.

When a fluoropolymer is applied to a substrate, it may be applied in the form of the polymer or as precursors to the polymer which are in turn polymerized by thermal, photoinitiated, or redox polymerization.

Fluorinated polymer(s) and optional nonfluorinated polymer(s), or precursors thereof, can be combined with one or more curatives for enhanced curing rates and/or adhesion to the substrate. In particular, halogen-containing fluoropolymers (e.g., a terpolymer of TFE/HFP/VDF with brominated cure site monomer) can be cured with a peroxide curing system. Typically, a peroxide curing system includes an organic peroxide initiator (e.g., benzoyl peroxide, diisopropyl azodicarboxylate, tert-butyl peroxybenzoate, tert-butyl hydroperoxide, LUPERSOL 130 or 110 peroxides from Elf Ato Chem, Crosby, Tex.) and a multifunctional aliphatic unsaturated compound (e.g., triallyl isocyanurate (TAIC), trimethylolpropane trimethacrylate (TMPTMA), divinyl benzene, octadiene). Preferably, a peroxide curing system includes, for example, mixtures of triallyl isocyanurate (TAIC) or trimethylolpropane trimethacrylate (TMPTMA) with benzoyl peroxide (BP), and others commercially available from sources such as Aldrich.

For example, as shown in Tables 12 and 13, the adhesion of 3M DYNEON fluoropolymers E-15742 (a terpolymer of TFE/HFP/VDF with brominated cure site monomer) to polyurethanes can be improved by incorporating a peroxide curative (i.e., peroxide curing system) into fluoropolymer coating solutions.

A fluoropolymer can be applied onto the substrate by dipping, brushing, or spraying, by over-molding, extruding, or by any other suitable method. The fluoropolymers are preferably coated out of a liquid carrier (e.g., an organic solvent or water).

In dip coating process, the substrate is dipped in a coating liquid, removed, and dried. The coating liquid may be a solution. Suitable organic solvents used in coating compositions include, but are not limited to, methyl ethyl ketone (MEK), acetone, cyclohexanone, dimethyl sulfoxide, dimethylformamide, tetrahydrofuran, n-methylpyrrolidone, dimethylaceteamide, ethyl acetate, fluorinated solvents, and their mixtures. Preferably, the solvent dissolves the fluoropolymer and not the substrate (e.g., polyurethane).

The amount of a coating liquid should be sufficient to form a coating that is thick enough for stain resistance. The thickness of the protective fluoropolymer layer is preferably at least a monolayer, and sufficiently thin so as not to alter the bulk properties of the elastomeric substrate. Preferably, the thickness of a protective fluoropolymer layer is at least 0.01 micron, and more preferably at least 0.5 micron. Preferably, the thickness of a protective layer is no greater than 20 microns, and more preferably, no greater than 2.5 microns.

The desired coating thickness can be achieved by varying the concentration of the coating composition and the number of passes in the coating process, for example. A typical coating concentration is at least 1 wt-%, although lower concentrations can be used, however, more coating passes may be required. Preferably, the concentration of a coating composition is at least 3 wt-% of the fluoropolymer, based on the total weight of the composition. A typical concentration is no greater than 20 wt-%, although higher concentrations can be used. Preferably, the concentration of a coating composition is no greater than 10 wt-% of the fluoropolymer, based on the total weight of the composition.

The relationship of the coating thickness to the concentration of the coating composition is influenced by the viscosity of the coating composition. Polymers having higher molecular weights will give higher viscosity and therefore greater thickness.

Typical coating temperatures and times are sufficient for the coating composition to swell/penetrate the substrate surface, but not so high as to adversely affect the bulk properties of the elastomeric substrate. The coating temperature can be room temperature if the solubility of the fluoropolymer is sufficient to give the desired coating composition concentration. The coating composition may be heated to increase the solubility of the fluoropolymer when needed. A preferred coating time is 0.25 second to 10 minutes.

After the coating step, typically, the process includes a thermally curing process. The cure temperature and time are selected to form good bonding without compromising the bulk properties of the elastomeric substrate. Typically, such temperatures are at or above the melting temperature of the fluoropolymer but below the softening temperature of the elastomeric substrate. For example, for KYNAR 7201/PMMA (8:2 and 9:1) coatings on KYNAR 7201 polyurethane substrate, a preferred curing temperature is 120° C. to 150° C. and preferred curing time is 1 minute to 30 minutes.

When appropriate, a fluoropolymer can be applied to an elastomeric substrate after a cleaning step and/or a priming step. Priming herein refers to coating the substrate with a primer prior to application of the fluoropolymer.

A cleaning process typically includes washing the material with a solvent such as ethyl acetate, methyl ethyl ketone, methyl isobutyl ketone, acetone, toluene, and fluorinated solvents.

Primers include, for example, poly-1-lysine, DYNAMAR FC 5155 elastomer additive (3M Dyneon), and polyallylamine. A priming process can include, for example, priming with 0.1 weight/volume percent (w/v%) poly-1-lysine/water and optionally baked (e.g., at temperatures of, for example, 90° C., and times of, for example, 15 min).

An alternative method to enhance adhesion of fluoropolymer to the substrate is to incorporate an adhesion promoter into the fluoropolymer-containing composition. Examples of such adhesion promoters include multifunctional amines (such as those disclosed in U.S. Pat. No. 5,656,121 (Fukushi)), and aminosilanes (such as those disclosed in U.S. Pat. No. 6,753,087 (Jing et al.)).

The substantivity (i.e., adhesion) of the protective fluoropolymer layers of the present invention may be measured by a number of techniques. For example, one may evaluate whether or not a fluoropolymer layer remains after different assaults, such as toothbushing or soaking in boiling water.

In the toothbrushing test, the force and number of cycles are set to simulate 1 month human brushing. To demonstrate integrity of the fluoropolymer layer after such toothbrushing simulation, the samples can be subjected to a stain test where the fluoropolymer layer protects the sample from staining if the adhesion of the fluoropolymer remains good. Preferred fluoropolymer-coated samples of the current invention do not stain significantly in the stain test.

Adhesion can also be tested using a boiling water test, in which the samples are soaked in boiling water. If no delamination occurs, the interfacial adhesion is good. Adhesion of preferred coatings of the present invention can survive or remain unchanged even after immersing fluoropolymer-coated samples in boiling water for 3 hours.

Peel strength can be used to quantify the interfacial adhesion. See Example 7 for more description. A desirable peel strength from a polyurethane-containing film is preferably greater than 0.2 lb/in (0.4 N/cm), more preferably greater than 1 lb/in (1.8 N/cm), and most preferably greater than 4 lb/in (7.0 N/cm).

Stain resistance of the coatings of the present invention (particularly to foods, beverages, and bacteria) is particularly desirable.

Stain testing can be carried out in a variety of ways. For example, this can involve 24 hour immersion in 100% mustard and other staining agents, or 2 hour immersion in 50:50 mustard/water only. The samples can be in the form of films or ligatures, optionally stretched on a bracket.

The samples preferably show less staining in the stain test involving 24 hour immersion in a staining agent (e.g., mustard) (preferably, with a rating of less than 3, and more preferably 0 or 1 defined in Example 1) than the control. Preferably, the change in color after 24 hour immersion in a staining agent (e.g., mustard), ΔE (defined in Example 1), is less than 30.

Surprisingly, treated ligatures perform well in stain tests even after being prestretched (300% stretch), especially in the case of fluoropolymer PVDF and its blends with PMMA.

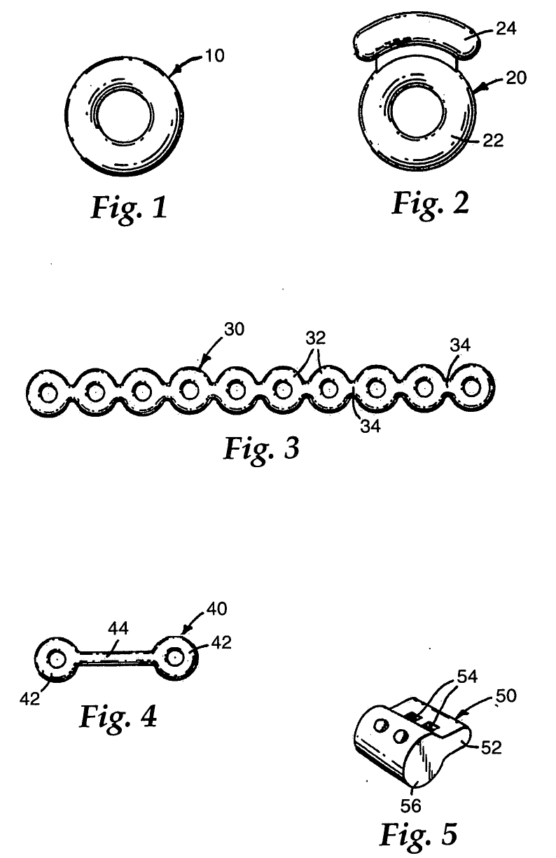

Referring now to the drawings, FIG. 1 illustrates a ligature or tensioning device 10 that can be coated with a stain-resistant fluoropolymer described herein. The annular device 10 has a circular cross-section, and resembles an O-ring. In use, the device 10 is stretched around tie wings of an orthodontic bracket and over an arch wire, in order to ligate the wire to the bracket and urge the wire toward a fully seated orientation in the bottom of a slot formed in the bracket.

Although not shown, the stain-resistant fluoropolymer layers described herein may also be used on a tooth separator device that is similar to but larger in size than the device 10 shown in FIG. 1. In use, the tooth separator device is placed between selected teeth to urge the teeth apart and provide a space for subsequent installation of a metal band. The band may serve as a base for a bracket or, if placed on the molars, serve as a base for a buccal tube which receives the end of the arch wire.

FIG. 2 illustrates another orthodontic ligature device 20 which has an annular portion 22 that is similar in shape to the device 10; however, the device 20 also includes a bumper portion 24 such as described in U.S. Pat. No. 4,950,158 (Barngrover et al.). The bumper portion 24 extends over occlusal surfaces of the bracket in order to hinder direct contact of the bracket with an opposing tooth. This device can also be coated with a stain-resistant fluoropolymer described herein.

An elongated, chain-like tensioning module device 30 as shown in FIG. 3 can also be coated with a stain-resistant fluoropolymer described herein. It has a number of annular portions 32 that are interconnected by bridging portions 34. Each annular portion 32 is similar in configuration to the ligature device 10 shown in FIG. 1. In use, the device 30 is cut to an appropriate length. Next, some or all of the annular portions 32 are placed around tie wings of selected brackets in order to ligate the wire to those brackets. If the device 30 is in longitudinal tension, the teeth having brackets ligated by the device 30 will tend to move toward each other.

FIG. 4 illustrates an integrally molded elongated tensioning device 40 that can also be coated with a stain-resistant fluoropolymer described herein. The device 40 has a dogbone-shaped configuration with opposed annular end portions 42 that are similar in configuration to the device 10. The end portions 42 are interconnected by a flexible, somewhat cylindrical shaft portion 44. The annular portions 42 function to couple the device 40 to appropriate brackets and optionally ligate the arch wire to those brackets. The shaft portion 44, when placed in tension, urges the brackets connected to the annular portions 42 toward each other.

An integrally molded orthodontic rotation wedge device 50 is depicted in FIG. 5, and has a base 52 with two apertures 54 adapted to be placed over tie wings of a selected bracket. A somewhat cylindrical wedge portion 56 is placed in compression between the arch wire and adjacent surfaces of the tooth, and serves to rotate the tooth about its long axis. This device can also be coated with a stain-resistant fluoropolymer described herein.

### EXAMPLES

The following examples are given to illustrate, but not limit, the scope of this invention. Unless otherwise indicated, all parts and percentages are by weight, and all molecular weights are weight average molecular weight.

Materials

THV 220 is a terpolymer of TFE/HFPNDF.
KYNAR 7201 is a copolymer of VDF/TFE.
FLUOREL 2145, KYNAR Super Flex 2501 and KYNAR Flex 2751 are copolymers of VDF/HFP.
E-15742 is a terpolymer of TFE/HFP/VDF with brominated cure site monomer.
TFE is tetrafluoroethylene.
HFP is hexafluoropropylene.
VDF is vinylidene fluoride.

### Example 1

### Stain Resistance of Fluoropolymer-Coated Polyurethane Films

Two thermoplastic polyurethanes, available under the trade designations TEXIN 285 (Bayer) and PELLETHANE 2363 (Dow), were extruded into 0.012 inch (0.030 cm) and 0.020 inch (0.051 cm) thick films, respectively, cleaned with ethyl acetate and air dried. Tables 1 and 2 list examples of fluoropolymer-coated TEXIN films and Tables 3 and 4 list examples of fluoropolymer-coated PELLETHANE films. Five types of coating materials were applied to both types of films. These coating materials included the fluoropolymer materials available under the trade designations THV 220 (3M Dyneon), KYNAR 7201 (Atofina), FLUOREL FC2145 (3M Dyneon, a fluoroelastomer), as well as blends of 8:2 and 9:1 KYNAR 7201: polymethyl methacrylate (PMMA M_{w} 120,000 from Aldrich). All of the five coating materials were dissolved in methyl ethyl ketone (MEK). The films were dip coated in 1, 3, 5, and 10% solutions at room temperature followed by a thermal cure at 140° C. for 15 minutes (min).

The coated film samples were subjected to stain tests as follows. Different samples were immersed in mustard (that available under the trade designation FRENCH'S), spaghetti sauce (that available under the trade designation RAGU OLD WORLD Style flavored with meat), tea (prepared from that available under the trade designation LIPTON Orange Pekoe), and coffee (prepared from that available under the trade designation CALISTOGA French Roast), respectively for 24 hours at room temperature, removed, rinsed thoroughly with water, and blotted dry. To determine the color difference of the sample before and after the stain test, samples after being subjected to the stain test were placed on white paper next to a control, which did not undergo the stain test. A rating of 0 to 4 was given to each sample where 0 indicated no visible staining, 1 indicated slight staining, 2 indicated moderate staining, 3 indicated heavy staining, and 4 indicated severe staining.

In addition to visually rating the samples, the colors of the samples were also determined by a spectrometer (No. EPP200C, from StellarNet, Inc.) before and after the stain test. The spectrometer was fitted with a fiber optic reflectance probe (R400-7-visNIR), a Toshiba photo-diode array, a 25-micron slit, and a miniature 5-Watt fiber optic vis/NIR light source (SLI). A dark scan was taken by covering the probe with the non-adhesive side of a section of a black electrical tape to set up a background value. The fiber optic probe was positioned 0.6 cm away from the surface of a white Halon reflectance standard (RS50). The probe was adjusted so that the axis of the probe was approximately 45° with respect to the surface of the standard. After switching the light source on and adjusting the integration time so the curve covered 90% of the scale, a reference spectrum was saved. With the fiber optic source turned off, the sample was placed on the white reflectance standard. The light source was then turned on and spectrometer used to capture the reflectance spectrum and convert it to CIELAB L*, a* and b* values (“Colorimetry,” Robert T. Marcus, Measurement, Instrumentation, and Sensors Handbook, Ed. John G. Webster, CRC Press, 1999). The color difference before and after the stain test, ΔE, was calculated as follows:
ΔE=[(L*−L*₀)²+(a*−a*₀)²+(b*−b*₀)²]^{0.5}
where the subscript o denotes initial color measurement before the stain test. A small color difference (ΔE) as a result of the stain test indicated the sample was less susceptible to staining.

The stain test results of coated films after simulated 1-month toothbrushing are in Tables 1-2 for TEXIN polyurethane and Tables 3-4 for PELLETHANE polyurethane. Simulated 1-month toothbrushing was conducted with the following parameters developed from in vivo human studies: a brushing/pressing force of 2.7 N, a brushing frequency of 1.12 cycles/sec, and 783 cycles to be equivalent to one month of human brushing (“Clinical Estimation of Toothbrushing Effort,” M. R. Pintado, J. P. Beyer, R. DeLong, E. S. Reeh and W. H. Douglas, Journal of Dental Research, 71 (AADR Abstracts), No. 961, 1992). The coated samples were immersed in a 50/50 slurry of toothpaste/water (CREST brand Regular toothpaste), and brushed with a soft toothbrush (ORAL B 40 Regular soft toothbrush). A small color difference in the stain test after brushing indicated that the abrasion resistance of the coating material was sufficient to withstand a 1-month period of toothbrushing. Compared to uncoated films (Table 5), the coated films were far superior in stain resistance even after brushing. The experimental results demonstrated that the preferred fluoropolymer concentration range was 3 weight percent (wt-%) to 10 wt-%, while a concentration of 1 wt-% provided less satisfactory coatings for stain resistance.

TABLE 1
Stain test results of coated TEXIN films after brushing:
visual rating (0: no visible staining, 1: slight staining, 2: moderate staining,
3: heavy staining and 4: severe staining)

| Fluoropolymer coating solutions | | | | | |
|---|---|---|---|---|---|
| (in MEK) (percentages | | | Spaghetti | | |
| are in weight percents) | | Mustard | sauce | Tea | Coffee |
| THV 220 | 1% | 1 | 0 | 0 | 0 |
| | 3% | 0 | 0 | 0 | 0 |
| | 5% | 0 | 0 | 0 | 0 |
| | 10% | 0 | 0 | 0 | 0 |
| KYNAR | 1% | 0 | 0 | 0 | 0 |
| | 3% | 0 | 0 | 0 | 0 |
| | 5% | 0 | 0 | 0 | 0 |
| | 10% | 0 | 0 | 0 | 0 |
| 8:2 KYNAR:PMMA | 1% | 0 | 0 | 0 | 0 |
| | 3% | 0 | 0 | 0 | 0 |
| | 5% | 0 | 0 | 0 | 0 |
| | 10% | 0 | 0 | 0 | 0 |
| 9:1 KYNAR:PMMA | 1% | 0 | 0 | 0 | 0 |
| | 3% | 0 | 0 | 0 | 0 |
| | 5% | 0 | 0 | 0 | 0 |
| | 10% | 0 | 0 | 0 | 0 |
| FLUOREL FC2145 | 1% | 3 | 0 | 0 | 0 |
| | 3% | 0 | 0 | 0 | 0 |
| | 5% | 1 | 0 | 0 | 0 |
| | 10% | 0 | 0 | 0 | 0 |

TABLE 2
Stain test results of coated TEXIN films after brushing:
calculated color change ΔE

| Fluoropolymer coating solutions | | | | | |
|---|---|---|---|---|---|
| (in MEK) (percentages | | | Spaghetti | | |
| are in weight percents) | | Mustard | sauce | Tea | Coffee |
| THV 220 | 1% | 16.6 | 16.2 | 5.1 | 5.7 |
| | 3% | 4.7 | 17.1 | 20.1 | 3.8 |
| | 5% | 3.0 | 5.8 | 1.4 | 6.3 |
| | 10% | 18.1 | 18.2 | 18.5 | 29.7 |
| KYNAR | 1% | 7.3 | 5.0 | 7.2 | 14.2 |
| | 3% | 3.4 | 1.9 | 12.0 | 9.4 |
| | 5% | 4.9 | 2.7 | 16.0 | 6.3 |
| | 10% | 2.4 | 2.1 | 4.9 | 7.9 |
| 8:2 KYNAR:PMMA | 1% | 10.4 | 9.3 | 2.4 | 1.2 |
| | 3% | 1.2 | 3.9 | 3.0 | 14.5 |
| | 5% | 7.9 | 8.2 | 5.7 | 6.5 |
| | 10% | 2.1 | 3.7 | 0.8 | 2.6 |
| 9:1 KYNAR:PMMA | 1% | 1.5 | 10.5 | 12.9 | 13.3 |
| | 3% | 6.6 | 5.5 | 2.9 | 10.9 |
| | 5% | 4.5 | 1.6 | 3.6 | 4.2 |
| | 10% | 12.7 | 2.2 | 3.2 | 1.4 |
| FLUOREL FC2145 | 1% | 39.7 | 4.2 | 4.7 | 17.7 |
| | 3% | 9.4 | 6.1 | 10.4 | 4.4 |
| | 5% | 8.3 | 14.2 | 15.6 | 15.0 |
| | 10% | 5.6 | 7.0 | 3.5 | 6.3 |

TABLE 3
Stain test results of coated PELLETHANE films after brushing:
visual rating (0: no visible staining, 1: slight staining, 2: moderate staining,
3: heavy staining and 4: severe staining)

| Fluoropolymer coating solutions | | | | | |
|---|---|---|---|---|---|
| (in MEK) (percentages | | | Spaghetti | | |
| are in weight percents) | | Mustard | sauce | Tea | Coffee |
| THV 220 | 1% | 2 | 0 | 0 | 0 |
| | 3% | 3 | 0 | 0 | 0 |
| | 5% | 2 | 0 | 0 | 1 |
| | 10% | 0 | 0 | 0 | 0 |
| KYNAR | 1% | 2 | 0 | 0 | 0 |
| | 3% | 1 | 0 | 0 | 0 |
| | 5% | 0 | 0 | 0 | 0 |
| | 10% | 0 | 0 | 0 | 0 |
| 8:2 KYNAR:PMMA | 1% | 2 | 0 | 0 | 0 |
| | 3% | 0 | 0 | 0 | 0 |
| | 5% | 0 | 0 | 0 | 0 |
| | 10% | 0 | 0 | 0 | 0 |
| 9:1 KYNAR:PMMA | 1% | 1 | 0 | 0 | 0 |
| | 3% | 0 | 0 | 0 | 0 |
| | 5% | 0 | 0 | 0 | 0 |
| | 10% | 0 | 0 | 0 | 0 |
| FLUOREL FC2145 | 1% | 1 | 0 | 0 | 0 |
| | 3% | 0 | 0 | 0 | 0 |
| | 5% | 0 | 0 | 0 | 0 |
| | 10% | 0 | 0 | 0 | 0 |

TABLE 4
Stain test results of coated PELLETHANE films after brushing:
calculated color difference ΔE

| Fluoropolymer coating solution | | | | | |
|---|---|---|---|---|---|
| (in MEK) (percentages | | | Spaghetti | | |
| are in weigth percents) | | Mustard | sauce | Tea | Coffee |
| THV 220 | 1% | 55.7 | 18.1 | 24.4 | 9.2 |
| | 3% | 53.6 | 10.9 | 5.4 | 16.9 |
| | 5% | 39.5 | 8.7 | 1.6 | 9.0 |
| | 10% | 2.3 | 3.7 | 12.6 | 8.0 |
| KYNAR | 1% | 11.6 | 16.1 | 15.4 | 10.4 |
| | 3% | 6.7 | 8.0 | 13.1 | 5.6 |
| | 5% | 1.8 | 2.3 | 20.6 | 8.6 |
| | 10% | 2.5 | 4.5 | 7.8 | 10.3 |
| 8:2 KYNAR:PMMA | 1% | 23.7 | 14.3 | 2.8 | 14.9 |
| | 3% | 3.4 | 3.0 | 12.0 | 5.3 |
| | 5% | 3.1 | 2.9 | 1.8 | 2.9 |
| | 10% | 6.9 | 10.2 | 1.9 | 4.7 |
| 9:1 KYNAR:PMMA | 1% | 16.1 | 10.9 | 4.5 | 8.5 |
| | 3% | 3.0 | 2.1 | 9.4 | 14.2 |
| | 5% | 5.1 | 5.1 | 9.8 | 15.4 |
| | 10% | 4.2 | 3.2 | 3.6 | 14.9 |
| FLUOREL FC2145 | 1% | 32.3 | 7.5 | 5.8 | 6.7 |
| | 3% | 10.3 | 5.6 | 6.6 | 6.8 |
| | 5% | 11.3 | 9.8 | 5.0 | 8.0 |
| | 10% | 6.2 | 6.3 | 5.4 | 9.3 |

TABLE 5
Stain test results of uncoated TEXIN films: visual rating
(0: no visible staining, 1: slight staining, 2: moderate staining, 3: heavy
staining and 4: severe staining) and calculated color difference ΔE

| | Visual or | | Spaghetti | | |
|---|---|---|---|---|---|
| Sample | spectrometer | Mustard | sauce | Tea | Coffee |
| TEXIN | Visual rating | 3 | 1 | 1 | 2 |
| polyurethane 285 | Calculated | 67.3 | 4.9 | 10.3 | 19.9 |
| 0.034-inch | color | | | | |
| (0.086 cm) thick | difference ΔE | | | | |
| CONTROL | | | | | |

### Example 2

### Stain Resistance of Fluoropolymer-Coated Polyurethane Chains

Table 6 lists examples of fluoropolymer-coated chains. Thermoplastic polyurethane chains (available under the trade designation 3M Unitek AlastiK CK REF 406-622) were cleaned with ethyl acetate, air dried and dip coated at room temperature with four fluoropolymer coating materials described in Example 1: KYNAR 7201, THV 220, 9:1 KYNAR:PMMA, and 8:2 KYNAR:PMMA. The coating solution concentrations were 7 wt-% (Samples 1-4 in Table 6) and 10 wt-% (Samples 5-8 in Table 6) in MEK. The coated chains were cured at 140° C. for 15 min.

Two types of stain tests were performed. One stain test was conducted after the simulated one-month toothbrushing test using the same procedures as in Example 1. The other stain test had one link of the chain stretched on a bracket (available under the trade designation 3M Unitek Clarity REF 6400-601) during the 24-hour test period. A small color difference in this test indicated the stain resistant coating could withstand being stretched and still strongly and uniformly adhere to the substrate. The results in Table 6 showed that the stain resistance of fluoropolymer-coated chains was significantly proved over the uncoated chain even after being stretched on a bracket and after brushing.

TABLE 6
Stain test results of fluoropolymer-coated AlastiK CK chains:
visual rating (0: no visible staining, 1: slight staining, 2: moderate staining,
3: heavy staining and 4: severe staining)

| | Fluoropolymer coating | Stain | | Spaghetti | | |
|---|---|---|---|---|---|---|
| No. | solution (in MEK) | test condition | Mustard | sauce | Tea | Coffee |
| 1 | KYNAR (7 wt-%) | Stretched on | 2 | 0 | 0 | 1 |
| | | bracket | | | | |
| | | After brushing | 2 | — | — | — |
| 2 | THV 220 (7 wt-%) | Stretched on | 2 | 0 | 0 | 1 |
| | | bracket | | | | |
| | | After brushing | 2 | — | — | — |
| 3 | 9:1 | Stretched on | 2 | 0 | 0 | 1 |
| | KYNAR:PMMA | bracket | | | | |
| | (7 wt-%) | After brushing | 2 | 0 | — | — |
| 4 | 8:2 | Stretched on | 2 | 0 | 0 | 1 |
| | KYNAR:PMMA | bracket | | | | |
| | (7 wt-%) | After brushing | 2 | 0 | — | 1 |
| 5 | KYNAR | Stretched on | 2 | 0 | 0 | 1 |
| | (10 wt-%) | bracket | | | | |
| | | After brushing | 1 | 0 | — | — |
| 6 | THV 220 | Stretched on | 2 | 0 | 0 | 1 |
| | (10 wt-%) | bracket | | | | |
| | | After brushing | 2 | 0 | 0 | 2 |
| 7 | 9:1 | Stretched on | 2 | 0 | 0 | 1 |
| | KYNAR:PMMA | bracket | | | | |
| | (10 wt-%) | After brushing | 1 | 0 | — | 1 |
| 8 | 8:2 | Stretched on | 2 | 0 | 0 | 1 |
| | KYNAR:PMMA | bracket | | | | |
| | (10 wt-%) | After brushing | 1 | 0 | — | 1 |
| 9 | No coating CONTROL | Stretched on | 3 | 0 | 0 | 3 |
| | | bracket | | | | |

### Example 3

### Stain Resistance of Fluoropolymer-Coated Polyurethane Ligatures

Similar to coated chains described above, thermoplastic polyurethane ligatures (available under the trade designation 3M Unitek AlastiK Easy-To-Tie ligature REF 406-870) were cleaned with ethyl acetate, air dried and dip coated at room temperature with 3 coating materials: 8:2 KYNAR:PMMA, 9:1 KYNAR:PMMA, and KYNAR 7201, all at 8.5% concentration in MEK (Samples 10-12 in Table 7). The coated ligature samples were cured at 140° C. for 15 min. The same ligature was also dip coated at 80° C. with 10% 8:2 KYNAR:PMMA in MEK (Sample 13 in Table 7) and cured at 150° C. for 15 min. A stain test was performed with the ligature stretched on a bracket (available under the trade designation 3M Unitek Clarity REF 6400-601) during the 24-hour test period. The results in Table 7 showed much improved stain resistance of fluoropolymer-coated ligatures compared to the uncoated control even after being stretched on bracket.

TABLE 7
Stain test results of fluoropolymer-coated AlastiK Easy-To-Tie ligatures:
visual rating (0: no visible staining, 1: slight staining, 2: moderate staining,
3: heavy staining and 4: severe staining)

| | Fluoropolymer | | | Spa- | | |
|---|---|---|---|---|---|---|
| | coating solution | Stain test | | ghetti | | |
| No. | (in MEK) | condition | Mustard | sauce | Tea | Coffee |
| 10 | 8:2 | Stretched | 0 | 0 | 0 | 0 |
| | KYNAR:PMMA | on bracket | | | | |
| | (8.5 wt-%) | | | | | |
| 11 | 9:1 | Stretched | 1 | 0 | 0 | 0 |
| | KYNAR:PMMA | on bracket | | | | |
| | (8.5 wt-%) | | | | | |
| 12 | KYNAR | Stretched | 0 | 0 | 0 | 0 |
| | (8.5 wt-%) | on bracket | | | | |
| 13 | 8:2 | Stretched | 0 | 0 | 0 | 1 |
| | KYNAR:PMMA | on bracket | | | | |
| | (10 wt-%) | | | | | |
| 14 | No coating | Stretched | 3 | 1 | 0 | 3 |
| | CONTROL | on bracket | | | | |

### Example 4

### Stain Resistance of THV-Coated Ligatures and Chains

Table 8 lists examples of THV-coated ligatures (Samples 1-2) and chains (Samples 4-7). One thermoplastic polyurethane ligature (available under the trade designation 3M Unitek AlastiK QuiK-StiK A1 REF 406-417) and two types of thermoplastic polyurethane chains (available under the trade designations 3M Unitek AlastiK C-1 REF 406-031 and CK REF 406-622) were dip-coated with 5.6% THV220 (3M Dyneon)/MEK solution in 2 passes or 4 passes, after being primed with 0.1 weight/volume percent (w/v%) poly-1-lysine/water and baked at 90° C. for 15 min. The THV-coated ligature and chains were cured at 150° C. for 15 min at the end of each pass except for Samples 1-2, for which the first pass was cured at 90° C. for 15 min. Two types of stain tests described in Example 2 were performed: 1) after simulated 1-month brushing; and 2) stretched on bracket during the 24-hour test period. A third type of stain test was conducted with the force module stretched on a bracket for 1 month followed by the 1-day stain test (still stretched on bracket during the 24-hour test period). The stain test results in Table 8 indicated that the THV-coated ligature (Sample 1) and chains (Samples 4-7) were much improved in stain resistance compared to the uncoated controls (Sample 3 and Sample 8) even after being stretched on a bracket. The THV-coated chains also had better stain resistance than the uncoated chain even after brushing. Increasing the number of passes from 2 to 4 in THV-coated chain further improved the stain resistance (Samples 4-5 and Samples 6-7). In case the primer was applied but not baked (Sample 2), the THV-coated ligature had less improvement in stain resistance than that with primer bake (Sample 1).

TABLE 8
Stain test results of THV-coated AlastiK ligatures and chains:
visual rating (0: no visible staining, 1: slight staining, 2: moderate staining,
3: heavy staining and 4: severe staining)

| | | | | Spa- | | |
|---|---|---|---|---|---|---|
| | | Stain test | | ghetti | | |
| No. | Sample ID | condition | Mustard | sauce | Tea | Coffee |
| 1 | QuiK-StiK | Stretched on | 1 | — | 0 | 1 |
| | ligature A1 | bracket | | | | |
| | THV-coated | Stretched on | 1 | 1 | 1 | 2 |
| | (2 passes) | bracket for 1 | | | | |
| | | month followed | | | | |
| | | by stain test | | | | |
| 2 | QuiK-StiK | Stretched on | 2 | — | 0 | 1 |
| | ligature A1 | bracket | | | | |
| | THV-coated | | | | | |
| | (2 passes) | | | | | |
| | without primer | | | | | |
| | bake | | | | | |
| 3 | QuiK-StiK | Stretched on | 3 | 1 | 0 | 3 |
| | ligature A1 | bracket | | | | |
| | CONTROL | | | | | |
| 4 | C-1 chain | Stretched on | 1 | 0 | 0 | 0 |
| | (molded) | bracket | | | | |
| | THV-coated | After brushing | 2 | 0 | 0 | 1 |
| | (2 passes) | | | | | |
| 5 | CK chain | Stretched on | 1 | 0 | 0 | 1 |
| | (die-cut) | bracket | | | | |
| | THV-coated | After brushing | 2 | 0 | 0 | 0 |
| | (2 passes) | | | | | |
| 6 | C-1 chain | Stretched on | 0 | 0 | 0 | 0 |
| | (molded) | bracket | | | | |
| 5 | THV-coated | After brushing | 1 | 0 | 0 | 0 |
| | (4 passes) | | | | | |
| 7 | CK chain | Stretched on | 1 | 0 | 0 | 1 |
| | (die-cut) | bracket | | | | |
| 6 | THV-coated | After brushing | 1 | 0 | 0 | 1 |
| | (4 passes) | | | | | |
| 8 | CK chain | Stretched on | 3 | 0 | 0 | 3 |
| | (die-cut) | bracket | | | | |
| | CONTROL | | | | | |

### Example 5

### Water Contact/Receding Angle of Fluoropolymer-Coated Polyurethane Films

One thermoplastic polyurethane was extruded, cleaned, air dried, coated with five coating materials and baked as described in Example 1, except that the coating solution concentration was kept at 8.5 wt-% for all coated materials and that coating was applied to one side of the film using a wire-wound-rod coater (Meyer rod). Glass slides (VWR Scientific Micro Slide) were cleaned by immersing them into a solution of ⅔ (volume) of concentrated sulfuric acid and ⅓ (volume) of 33 wt-% hydrogen peroxide. The cleaned glass slides were immediately coated on one side using Meyer rod with the same five coating materials and baked at 140° C. for 10 min.

Water contact angle measurements were made using deionized water filtered through a MILLIPORE filtration system on an AST Products (Billerica, Mass.) VCA-2500XE Video Contact Angle Analyzer. Reported values are the average of measurements on at least three drops measured on the coated side. Drop volumes were 5 μL for the static measurement and 1-3 μL for the receding measurement. Results in Table 10 show that the fluoropolymer-coated polyurethane films behave like fluoropolymers, not like polyurethane.

TABLE 10
Contact/Receding angle measurements on the fluoropolymer-
coated glass slide and polyurethane films

| | | Contact | |
|---|---|---|---|
| | Fluoropolymer/MEK | Angle, | Receding Contact |
| Substrate | solution (8.5 wt-%) | degrees | Angle, degrees |
| Glass slide | THV 220 | 102 | 83 |
| | FLUOREL FC2145 | 101 | 82 |
| | KYNAR | 86 | 75 |
| | 9:1 KYNAR/PMMA | 87 | 77 |
| | 8:2 KYNAR/PMMA | 88 | 76 |
| TEXIN | No coating | 85 | 64 |
| | THV 220 | 102 | 83 |
| | FLUOREL FC2145 | 101 | 82 |
| | KYNAR | 87 | 77 |
| | 9:1 KYNAR/PMMA | 87 | 77 |
| | 8:2 KYNAR/PMMA | 87 | 75 |

### Example 6

### Coating Thickness of Fluoropolymer-Coated Polyurethane Films

Two thermoplastic polyurethanes were extruded, cleaned, air dried, dip coated with five coating materials and baked as described in Example 1, except that the coating solution concentration was 1, 2, 3 and 5 wt-% for all coated materials.

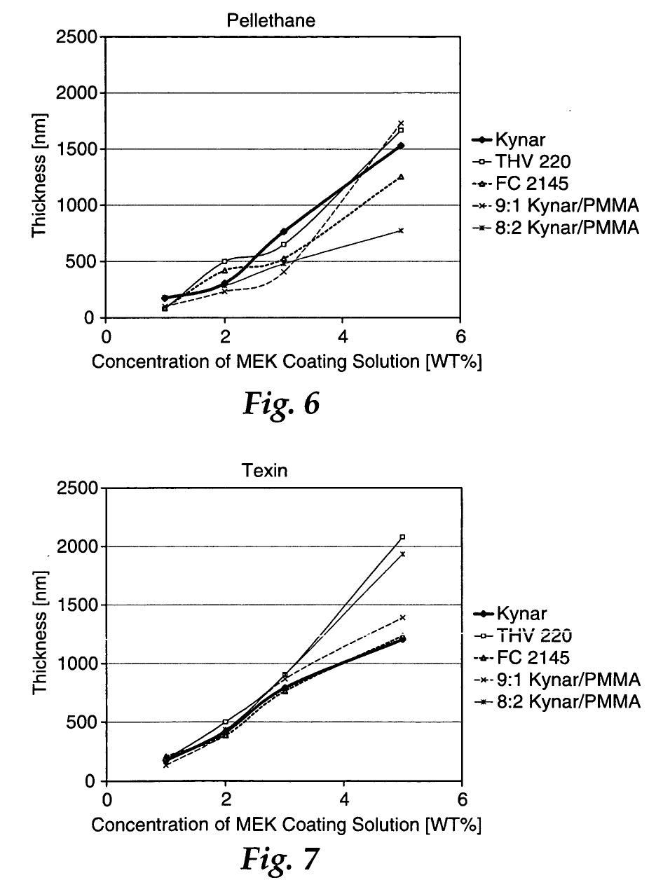

Coating thickness was measured by ellipsometry using M2000 Variable Angle Spectral Ellipsometer from J. A. Woolam Co., Inc. Results in FIGS. 6 (PELLETHANE substrate) and 7 (TEXIN substrate) indicate that the stain-resistant coating ranges from 100 nanometers (run) to 2000 run in thickness depending on the applied fluoropolymer solution concentration.

The relationship of thickness to concentration is influenced by the viscosity of the coating solution. Polymers having higher molecular weights will give higher viscosity and therefore greater thickness. In case of a “theta solvent,” polymers with higher molecular weights would have lower viscosity in solution; therefore coating thickness curves may have an opposite trend from those shown in FIGS. 6 and 7.

### Example 7

### Interfacial Adhesion Tests

Two thermoplastic polyurethanes were extruded, cleaned, air dried, coated with four coating materials and cured as described in Example 1 except that the coating solution concentration was kept at 8.5 wt-%. Additionally, ten weight percent solutions of the E-15742 bromo-fluoroelastomer (which is available from 3M Dyneon) in MEK were either directly used for coating or combined with a variety of concentrations of curatives (triallylisocyanurate (TAIC), trimethylolpropane trimethacrylate (TMPTMA), and benzoyl peroxide (BP), from Aldrich) described in Tables 12 and 13 for coating. The concentration of the curatives was based on the percentage in the fluoropolymer, not the final coating solution concentration. After coating, the samples were heated at 140° C. for 10 min.

To determine the interfacial adhesion between the fluoropolymer and the substrate, two tests were performed. The first test was boiling water immersion. The coated samples were immersed in boiling water for 3 hours. The samples were removed from boiling water and the interface was inspected to determine if the coated fluoropolymer layers were delaminated or not. The results are listed in Table 12.

Peel strength was the second test to determine interfacial adhesion. To facilitate testing of the adhesion between the layers via a T-peel test, a thick film (20 mil (0.51 mm)) of THV 220 or polyvinylidene fluoride (PVDF) was laminated onto the side of the films with the fluoropolymer coating in order to gain enough thickness for peel measurement. In some cases, a slight force was applied to the laminated sheet to keep a good surface contact. A strip of TEFLON-coated fiber sheet was inserted about 0.25 inch (0.64 mm) along the short edge of the 2 inch×3 inch (5.08 cm×7.62 cm) laminated sheet between the substrate surface and the fluoropolymer film to provide unbonded region to act as tabs for the peel test. The laminated sheet was then pressed at 200° C. for 2 minutes between heated platens of a Wabash Hydraulic Press (Wabash Metal Products Company, Inc., Hydraulic Division, Wabash, Ind.) and immediately transferred to a cold press. After cooling to room temperature by the cold press, the resulting sample was subjected to T-peel measurement.

Peel strengths of the laminated samples were determined following the test procedures described in ASTM D-1876 entitled “Standard Test Method for Peel Resistance of Adhesives,” more commonly known as the “T-peel” test. Peel data was generated using an INSTRON Model 1125 Tester (available from Instron Corp., Canton, Mass.) equipped with a Sintech Tester 20 (available from MTS Systems Corporation, Eden Prairie, Minn.). The INSTRON tester was operated at a cross-head speed of 4 inches/min (10.2 cm/min). Peel strength was calculated as the average load measured during the peel test and reported in pounds per inch (lb/inch) width (and N/cm) as an average of at least two samples. The results are shown in Table 13.

The results in Tables 12 and 13 demonstrate that the interfacial adhesion of the fluoropolymer to polyurethane is extremely good even after immersing fluoropolymer-coated samples in boiling water for 3 hours. This is especially true in the cases of Kynar and its blend coatings, and of bromo-containing fluoropolymers in combination with peroxide curatives.

TABLE 12
Fluoropolymer/Polyurethane interfacial adhesion tests after
immersion in boiling water

| | Fluoropolymer/ | |
|---|---|---|
| | MEK coating | |
| Substrate | solution | Boiling water testing |
| TEXIN | KYNAR (8.5 wt-%) | No delamination |
| TEXIN | 9:1 KYNAR/PMMA | No delamination |
| | (8.5 wt-%) | |
| TEXIN | 8:2 KYNAR/PMMA | No delamination |
| | (8.5 wt-%) | |
| TEXIN | THV 220 (8.5 wt-%) | No delamination, peelable |
| TEXIN | E-15742 (10 wt-%) | Delamination |
| TEXIN | E-15742 (10 wt-%), | No delamination, peelable |
| | TAIC (5 wt-%), | |
| | BP (1 wt-%) | |
| TEXIN | E-15742 (10 wt-%), | No delamination, peelable |
| | TMPTMA (2 wt-%), | |
| | BP (1 wt-%) | |
| TEXIN | E-15742 (10 wt-%), | No delamination, peelable |
| | TMPTMA (5 wt-%), | |
| | BP (1 wt-%) | |
| PELLETHANE | KYNAR (8.5 wt-%) | No delamination |
| PELLETHANE | 9:1 KYNAR/PMMA | No delamination |
| | (8.5 wt-%) | |
| PELLETHANE | 8:2 KYNAR/PMMA | No delamination |
| | (8.5 wt-%) | |
| PELLETHANE | THV 220 (8.5 wt-%) | Delamination |
| PELLETHANE | E-15742 (10 wt-%) | Delamination |
| PELLETHANE | E-15742 (10 wt-%), | No delamination, peelable |
| | TAIC (5 wt-%), | |
| | BP (1 wt-%) | |

TABLE 13
Fluoropolymer/Polyurethane Peel strength

| | | Laminating | |
|---|---|---|---|
| | Fluoropolymer/MEK | sheet used | Peel strength, |
| Substrate | coating solution | in pressing | lb/in (N/cm) |
| TEXIN | KYNAR (8.5 wt-%) | PVDF | 7.6 (13.3) |
| TEXIN | 9:1 KYNAR/PMMA | PVDF | 8.5 (14.9) |
| | (8.5 wt-%) | | |
| TEXIN | 8:2 KYNAR/PMMA | PVDF | 8.9 (15.6) |
| | (8.5 wt-%) | | |
| TEXIN | THV 220 (8.5 wt-%) | THV 220 | Not Measured |
| TEXIN | E-15742 (10 wt-%) | THV 220 | 0.2 (0.4) |
| TEXIN | E-15742 (10 wt-%), | THV 220 | 1.6 (2.8) |
| | TAIC (5 wt-%), | | |
| | BP (1 wt-%) | | |
| TEXIN | E-15742 (10 wt-%), | THV 220 | 0.8 (1.4) |
| | TMPTMA (2 wt-%), | | |
| | BP (1 wt-%) | | |
| TEXIN | E-15742 (10 wt-%), | THV 220 | 0.5 (0.9) |
| | TMPTMA (5 wt-%), | | |
| | BP (1 wt-%) | | |
| PELLETHANE | KYNAR (8.5 wt-%) | PVDF | 5.6 (9.8) |
| PELLETHANE | 9:1 KYNAR/PMMA | PVDF | 9.0 (15.8) |
| | (8.5 wt-%) | | |
| PELLETHANE | 8:2 KYNAR/PMMA | PVDF | 8.7 (15.2) |
| | (8.5 wt-%) | | |
| PELLETHANE | THV 220 (8.5 wt-%) | THV 220 | 0.4 (0.7) |
| PELLETHANE | E-15742 (10 wt-%) | THV 220 | 0.4 (0.7) |
| PELLETHANE | E-15742 (10 wt-%), | THV 220 | 4.5 (7.9) |
| | TAIC (5 wt-%), | | |
| | BP (1 wt-%) | | |

### Example 8

Polyurethane films (extruded from pellets available under the trade designations TEXIN and PELLETHANE as described in Example 1) or ligatures (available under the trade designation 3M Unitek AlastiK QuiK-StiK A1 REF 406-417 and Easy-To-Tie ligature REF 406-870) were thoroughly cleaned with ethyl acetate followed by air-drying. Such cleaned samples were typically coated at room temperature with the listed fluoropolymer materials described in Example 1 (THV 220, FLUOREL FC2145, 90:10 KYNAR/PMMA, and 80:20 KYNAR/PMMA in MEK) either by quick dipping (approximately 1 sec. or less) or immersing them into the coating solution for a certain period of time (e.g., 30 seconds, 60 seconds, etc.), as described in Table 14-21. The coated samples were dried at ambient conditions and cured in an oven at 140° C. for 15 min. or at other listed temperature for the listed time.

Two types of stain tests were performed. They both involved immersing the material in a mustard/water slurry for 2 hours. One stain test was conducted using unstretched films or ligatures. In the other stain test, films or ligatures were prestretched to 300% elongation using an INSTRON Tester, and allowed to return to unstreched state prior to stain test. The mustard/water slurry was a 50:50 mixture using mustard available under the trade designation FRENCH'S Classic. Both samples (unstretched and prestreched) were immersed into the same mustard/water slurry. The samples were then removed from the slurry, rinsed thoroughly with water, and dried at room temperature. To evaluate the degree of staining, unstretched and prestretched samples were placed next to each other on white paper as background along with controls that did not undergo the stain test. The stain testing results are shown in Tables 14-21. Note that a different rating scale was used in this example where “No” indicated no visual staining, “Very Light” indicated very light staining, “Light” indicated light staining and “Yes” indicated more than light staining.

TABLE 14
Stain repellency testing results on the fluoropolymer THV 220-coated TEXIN
and PELLETHANE film samples and orthodontic ligatures

| | | | | Dip | Cure | Regular | 300% |
|---|---|---|---|---|---|---|---|
| | | Fluoropolymer | Conc. | time | conditions | Stain | Stain |
| No. | Substrate | (in MEK) | (wt-%) | (sec) | (° C./min) | Test | Test |
| 1 | TEXIN | THV 220 | 5 | 30 | 140/15 | No | No |
| 2 | TEXIN | THV 220 | 10 | 30 | 140/15 | No | No |
| 3 | PELLETHANE | THV 220 | 5 | 30 | 140/15 | No | No |
| 4 | PELLETHANE | THV 220 | 10 | 30 | 140/15 | No | No |
| 5 | QuiK-StiK | THV 220 | 1 | 30 | 140/15 | Yes | Yes |
| | ligature | | | | | | |
| 6 | QuiK-StiK | THV 220 | 2 | 30 | 140/15 | Yes | Yes |
| | ligature | | | | | | |
| 7 | QuiK-StiK | THV 220 | 3 | 30 | 140/15 | Light | Yes |
| | ligature | | | | | | |
| 8 | QuiK-StiK | THV 220 | 5 | 30 | 140/15 | Very | Light |
| | ligature | | | | | Light | |
| 9 | QuiK-StiK | THV 220 | 5 | Quick | 140/15 | Very | Light |
| | ligature | | | dip | | Light | |
| 10 | QuiK-StiK | THV 220 | 5 | 30 | 160/15 | Very | Light |
| | ligature | | | | | Light | |
| 11 | QuiK-StiK | THV 220 | 5 | 30 | 160/30 | Very | Light |
| | ligature | | | | | Light | |

Table 14 shows the stain test results of THV-220 coated films and ligatures. For Samples 1-4, both TEXIN and PELLETHANE films coated with 5% and 10% THV-220/MEK solutions showed good stain resistance regardless whether the films were prestreched or not. The dip time was 30 sec and the cure condition was 140° C./15 min.

For Samples 5-8, increasing the coating solution concentration from 1% to 5% increased the stain resistance of THV-coated ligatures. Coating solution concentration of greater than 3% is preferred.

Sample 9 was coated the same as Sample 8 except that Sample 9 was dip coated quickly (about 0.25-2 sec.). Comparison of Samples 8 and 9 indicated that a short dip time gave as good results as 30 sec dip time. Comparison of Samples 8, 10, and 11 demonstrated that increasing the cure temperature from 140° C. to 160° C. and further increasing the cure time from 15 min. to 30 min. gave equally good stain resistance results.

TABLE 15
Stain repellency testing results on the fluoroelastomer FLUOREL FC2145-
coated TEXIN and PELLETHANE film samples and orthodontic ligatures

| | | | | | Cure | Regular | 300% |
|---|---|---|---|---|---|---|---|
| | | Fluoropolymer | Conc. | Dip | conditions | Stain | Stain |
| No. | Substrate | (in MEK) | (wt-%) | time (sec) | (° C./min) | Test | Test |
| 1 | TEXIN | FLUOREL | 3 | 30 | 140/15 | No | No |
| | | FC2145 | | | | | |
| 2 | TEXIN | FLUOREL | 5 | 30 | 140/15 | No | No |
| | | FC2145 | | | | | |
| 3 | TEXIN | FLUOREL | 10 | 30 | 140/15 | No | No |
| | | FC2145 | | | | | |
| 4 | PELLETHANE | FLUOREL | 3 | 30 | 140/15 | No | No |
| | | FC2145 | | | | | |
| 5 | PELLETHANE | FLUOREL | 5 | 30 | 140/15 | No | No |
| | | FC2145 | | | | | |
| 6 | PELLETHANE | FLUOREL | 10 | 30 | 140/15 | No | No |
| | | FC2145 | | | | | |
| 7 | QuiK-StiK | FLUOREL | 3 | 30 | 140/15 | No | Yes |
| | ligature | FC2145 | | | | | |
| 8 | QuiK-StiK | FLUOREL | 5 | 30 | 140/15 | Light | Yes |
| | ligature | FC2145 | | | | | |
| 9 | QuiK-StiK | FLUOREL | 10 | 30 | 140/15 | Very | Yes |
| | ligature | FC2145 | | | | Light | |

Table 15 shows the stain test results of FLUOREL FC2145-coated films and ligatures. For Samples 1-6, TEXIN and PELLETHANE films coated with FLUOREL FC2145 at 3%, 5% and 10 solutions, all gave good stain resistance results regardless whether the coated films were prestreched or not.

For Samples 7-9, QuiK-StiK ligatures coated with FLUOREL FC2145 at 3%, 5% and 10 solutions, gave good stain resistance results without prestrech. With prestrech, the FLUOREL-coated Quik-StiK ligatures did not have as good stain resistance as the THV-coated ligatures in Table 14.

TABLE 16
Stain repellency testing results on orthodontic
ligatures with various fluoropolymer coatings

| | | | | | Cure | Regular | 300% |
|---|---|---|---|---|---|---|---|
| | | Fluoropolymer | Conc. | Dip time | conditions | Stain | Stain |
| No. | Substrate | (in MEK) | (wt-%) | (sec) | (° C./min) | Test | Test |
| 1 | QuiK- | KYNAR | 5 | 30 | 140/15 | No | Light |
| | StiK | | | | | | |
| | ligature | | | | | | |
| 2 | QuiK- | THV 220 | 5 | 30 | 140/15 | No | Light |
| | StiK | | | | | | |
| | ligature | | | | | | |
| 3 | QuiK- | FLUOREL | 5 | 30 | 140/15 | Very | Yes |
| | StiK | FC2145 | | | | Light | |
| | ligature | | | | | | |
| 4 | QuiK- | 9:1 | 5 | 30 | 140/15 | No | No |
| | StiK | KYNAR/PMMA | | | | | |
| | ligature | | | | | | |
| 5 | QuiK- | 8:2 | 5 | 30 | 140/15 | No | No |
| | StiK | KYNAR/PMMA | | | | | |
| | ligature | | | | | | |
| 6 | QuiK- | KYNAR | 7 | 30 | 140/15 | No | Very |
| | StiK | | | | | | Light |
| | ligature | | | | | | |
| 7 | QuiK- | THV 220 | 7 | 30 | 140/15 | No | Very |
| | StiK | | | | | | Light |
| | ligature | | | | | | |
| 8 | QuiK- | 9:1 | 7 | 30 | 140/15 | No | No |
| | StiK | KYNAR/PMMA | | | | | |
| | ligature | | | | | | |
| 9 | QuiK- | 8:2 | 7 | 30 | 140/15 | No | No |
| | StiK | KYNAR/PMMA | | | | | |
| | ligature | | | | | | |

Table 16 shows the stain test results of ligatures coated with various fluoropolymers. Ligatures coated with KYNAR, THV 220, and blends of KYNAR and PMMA at both 5% and 7% concentrations showed very good stain test results. FLUOREL FC 2145-coated samples stained slightly even the ligature was not prestretched. Comparison of Samples 1-5 with Samples 6-9 demonstrated that ligatures coated with a 7 wt-% solution of varying fluoropolymers had slightly better stain resistance than those coated with a 5 wt-% solution.

TABLE 17
Stain repellency testing results on TEXIN and PELLETHANE
films with various fluoropolymer coatings

| | | | | PELLETHANE | | | |
|---|---|---|---|---|---|---|---|
| | | | | film | | TEXIN film | |
| | | Dip | Cure | Regular | | Regular | |
| Fluoropolymer | Conc. | time | conditions | Stain | 300% | Stain | 300% |
| (in MEK) | (wt-%) | (sec) | (° C./min) | Test | Stain Test | Test | Stain Test |
| KYNAR | 1 | 30 | 140/15 | Very | Very | Very | Very |
| | | | | light | light | light | light |
| THV 220 | 1 | 30 | 140/15 | Very | Very | Very | Very |
| | | | | light | light | light | light |
| 9:1 | 1 | 30 | 140/15 | Very | Very | Very | yes |
| KYNAR/PMMA | | | | light | light | light | |
| 8:2 | 1 | 30 | 140/15 | Very | Very | Very | yes |
| KYNAR/PMMA | | | | light | light | light | |
| KYNAR | 3 | 30 | 140/15 | No | No | No | No |
| THV 220 | 3 | 30 | 140/15 | No | No | No | No |
| 9:1 | 3 | 30 | 140/15 | No | No | No | No |
| KYNAR/PMMA | | | | | | | |
| 8:2 | 3 | 30 | 140/15 | No | No | No | No |
| KYNAR/PMMA | | | | | | | |
| KYNAR | 5 | 30 | 140/15 | No | No | No | No |
| THV 220 | 5 | 30 | 140/15 | No | No | No | No |
| 9:1 | 5 | 30 | 140/15 | No | No | No | No |
| KYNAR/PMMA | | | | | | | |
| 8:2 | 5 | 30 | 140/15 | No | No | No | No |
| KYNAR/PMMA | | | | | | | |
| KYNAR | 10 | 30 | 140/15 | No | No | No | No |
| THV 220 | 10 | 30 | 140/15 | No | No | No | No |
| 9:1 | 10 | 30 | 140/15 | No | No | No | No |
| KYNAR/PMMA | | | | | | | |
| 8:2 | 10 | 30 | 140/15 | No | No | No | No |
| KYNAR/PMMA | | | | | | | |

Table 17 shows the stain test results of TEXIN and PELLETHANE films coated with various fluoropolymers. Films coated with 3 wt-% or higher fluoropolymer solutions provided excellent stain resistance. However, the films coated with 1 wt-% fluoropolymer solutions were less stain resistant than those coated with higher concentrations. In general, these polyurethane films performed better in stain resistance than the corresponding ligatures made from the same resin. Shape and morphology of the substrate may have a significant influence on the coating process.

TABLE 18
Stain repellency testing results on ligatures with 80:20
KYNAR/PMMA fluoropolymer coatings

| | | | | Cure | Regular | |
|---|---|---|---|---|---|---|
| | Fluoropolymer | Conc. | Dip time | conditions | Stain | 300% |
| Substrate | (in MEK) | (wt-%) | (sec) | (° C./min) | Test | Stain Test |
| Easy-To-Tie | 8:2 | 3 | Quick | 140/15 | Light | Light |
| ligature | KYNAR/PMMA | | dip | | | |
| Easy-To-Tie | 8:2 | 5 | Quick | 140/15 | Very | Light |
| ligature | KYNAR/PMMA | | dip | | Light | |
| Easy-To-Tie | 8:2 | 7.5 | Quick | 140/15 | No | Very |
| ligature | KYNAR/PMMA | | dip | | | Light |
| Easy-To-Tie | 8:2 | 10 | Quick | 140/15 | No | No |
| ligature | KYNAR/PMMA | | dip | | | |
| Easy-To-Tie | 8:2 | 3 | 30 | 140/15 | Light | Light |
| ligature | KYNAR/PMMA | | | | | |
| Easy-To-Tie | 8:2 | 5 | 30 | 140/15 | Very | Very |
| ligature | KYNAR/PMMA | | | | Light | Light |
| Easy-To-Tie | 8:2 | 7.5 | 30 | 140/15 | No | Very |
| ligature | KYNAR/PMMA | | | | | Light |
| Easy-To-Tie | 8:2 | 10 | 30 | 140/15 | No | No |
| ligature | KYNAR/PMMA | | | | | |
| QuiK-StiK | 8:2 | 3 | Quick | 140/15 | Very | Very |
| ligature | KYNAR/PMMA | | dip | | Light | Light |
| QuiK-StiK | 8:2 | 5 | Quick | 140/15 | No | No |
| ligature | KYNAR/PMMA | | dip | | | |
| QuiK-StiK | 8:2 | 7.5 | Quick | 140/15 | No | No |
| ligature | KYNAR/PMMA | | dip | | | |
| QuiK-StiK | 8:2 | 10 | Quick | 140/15 | No | No |
| ligature | KYNAR/PMMA | | dip | | | |
| QuiK-StiK | 8:2 | 3 | 30 | 140/15 | No | No |
| ligature | KYNAR/PMMA | | | | | |
| QuiK-StiK | 8:2 | 5 | 30 | 140/15 | No | No |
| ligature | KYNAR/PMMA | | | | | |
| QuiK-StiK | 8:2 | 7.5 | 30 | 140/15 | No | No |
| ligature | KYNAR/PMMA | | | | | |
| QuiK-StiK | 8:2 | 10 | 30 | 140/15 | No | No |
| ligature | KYNAR/PMMA | | | | | |

Table 18 shows the stain test results of ligatures coated with 80:20 KYNAR/PMMA and the effect of dip time. No difference in stain repellency can be observed between quick dip coating and 30 seconds coating for both Easy-To-Tie and QuiK-StiK ligatures.

TABLE 19
Stain repellency testing results on ligatures with 80:20
KYNAR/PMMA fluoropolymer coatings

| | Fluoropolymer | | Cure | Regular | 300% |
|---|---|---|---|---|---|
| | (in MEK) | Dip time | conditions | Stain | Stain |
| Substrate | (10 wt-%) | (sec) | (° C./min) | Test | Test |
| Easy-To-Tie | 8:2 | Quick dip | 140/3 | No | No |
| ligature | KYNAR/PMMA | | | | |
| Easy-To-Tie | 8:2 | Quick dip | 140/5 | No | No |
| ligature | KYNAR/PMMA | | | | |
| Easy-To-Tie | 8:2 | Quick dip | 140/7.5 | No | No |
| ligature | KYNAR/PMMA | | | | |
| Easy-To-Tie | 8:2 | Quick dip | 140/10 | No | No |
| ligature | KYNAR/PMMA | | | | |
| Easy-To-Tie | 8:2 | Quick dip | 140/12 | No | No |
| ligature | KYNAR/PMMA | | | | |
| Easy-To-Tie | 8:2 | 30 | 140/3 | No | No |
| ligature | KYNAR/PMMA | | | | |
| Easy-To-Tie | 8:2 | 30 | 140/5 | No | No |
| ligature | KYNAR/PMMA | | | | |
| Easy-To-Tie | 8:2 | 30 | 140/7.5 | No | No |
| ligature | KYNAR/PMMA | | | | |
| Easy-To-Tie | 8:2 | 30 | 140/10 | No | No |
| ligature | KYNAR/PMMA | | | | |
| Easy-To-Tie | 8:2 | 30 | 140/12 | No | No |
| ligature | KYNAR/PMMA | | | | |
| QuiK-StiK | 8:2 | Quick dip | 140/3 | No | No |
| ligature | KYNAR/PMMA | | | | |
| QuiK-StiK | 8:2 | Quick dip | 140/5 | No | No |
| ligature | KYNAR/PMMA | | | | |
| QuiK-StiK | 8:2 | Quick dip | 140/7.5 | No | No |
| ligature | KYNAR/PMMA | | | | |
| QuiK-StiK | 8:2 | Quick dip | 140/10 | No | No |
| ligature | KYNAR/PMMA | | | | |
| QuiK-StiK | 8:2 | Quick dip | 140/12 | No | No |
| ligature | KYNAR/PMMA | | | | |
| QuiK-StiK | 8:2 | 30 | 140/3 | No | No |
| ligature | KYNAR/PMMA | | | | |
| QuiK-StiK | 8:2 | 30 | 140/5 | No | No |
| ligature | KYNAR/PMMA | | | | |
| QuiK-StiK | 8:2 | 30 | 140/7.5 | No | No |
| ligature | KYNAR/PMMA | | | | |
| QuiK-StiK | 8:2 | 30 | 140/10 | No | No |
| ligature | KYNAR/PMMA | | | | |
| QuiK-StiK | 8:2 | 30 | 140/12 | No | No |
| ligature | KYNAR/PMMA | | | | |

Table 19 shows the stain test results of ligatures coated with KYNAR/PMMA 80:20 (10 wt-% solution in MEK) and the effect of cure time. Excellent stain repellency was observed when the cure time was varied from 3 minutes to 12 minutes. The results are independent of the types of ligatures that were used and the dip time.

TABLE 20
Stain repellency testing results on ligatures with 80:20
KYNAR/PMMA fluoropolymer coatings from
10 wt-% coating solutions

| | Fluoropolymer | | Cure | Regular | 300% |
|---|---|---|---|---|---|
| | (in MEK) | Dip time | conditions | Stain | Stain |
| Substrate | (10 wt-%) | (sec) | (° C./min) | Test | Test |
| Easy-To-Tie | 8:2 | Quick dip | 110/15 | No | Very |
| ligature | KYNAR/PMMA | | | | Light |
| Easy-To-Tie | 8:2 | Quick dip | 120/15 | Very | Very |
| ligature | KYNAR/PMMA | | | Light | Light |
| Easy-To-Tie | 8:2 | Quick dip | 130/15 | No | Very |
| ligature | KYNAR/PMMA | | | | Light |
| Easy-To-Tie | 8:2 | Quick dip | 140/15 | No | No |
| ligature | KYNAR/PMMA | | | | |
| Easy-To-Tie | No coating | — | 150/15 | Yes | Yes |
| ligature | CONTROL | | | | |

The results shown in Table 20 shows the stain test results of ligatures coated with KYNAR/PMMA 80:20 (10 wt-% solution in MEK) and the effect of cure temperature. Coated ligatures exhibited good stain resistance when the cure temperature was varied from 10-140° C. In contrast, the uncoated control that was heat-treated for 15 minutes at 150° C. stained.

TABLE 21
Stain repellency testing results on ligatures with 80:20
KYNAR/PMMA fluoropolymer coatings

| | | Fluoropolymer | Coating | | Cure | Regular | 300% |
|---|---|---|---|---|---|---|---|
| | | (in MEK) | Temp. | Dip time | conditions | Stain | Stain |
| No. | Substrate | (10 wt-%) | (° C.) | (sec) | (° C./min) | Test | Test |
| 1 | QuiK-StiK | 8:2 | 80 | Quick | 140/15 | No | No |
| | ligature | KYNAR/PMMA | | dip | | | |
| 2 | QuiK-StiK | 8:2 | 80 | 30 | 140/15 | No | No |
| | ligature | KYNAR/PMMA | | | | | |
| 3 | QuiK-StiK | 8:2 | 80 | 60 | 140/15 | No | No |
| | ligature | KYNAR/PMMA | | | | | |
| 4 | QuiK-StiK | 8:2 | 80 | dip coat | 140/15 | No | No |
| | ligature | KYNAR/PMMA | | for 30 sec, | | | |
| | | | | dry, | | | |
| | | | | and dip | | | |
| | | | | coat for | | | |
| | | | | another | | | |
| | | | | 10 sec | | | |
| 5 | QuiK-StiK | 8:2 | 80 | dip coat | 140/15 | No | Very |
| | ligature | KYNAR/PMMA | | for 30 sec, | | | Light |
| | | | | dry, | | | |
| | | | | and dip | | | |
| | | | | coat for | | | |
| | | | | another | | | |
| | | | | 30 sec | | | |
| 6 | QuiK-StiK | 8:2 | 80 | 1 week | 140/15 | Very | Very |
| | ligature | KYNAR/PMMA | | | | light | light |
| 7 | QuiK-StiK | 8:2 | 80 | 1 week | No cure | Yes | Yes |
| | ligature | KYNAR/PMMA | | | | | |

QuiK-StiK ligatures in Table 21 were coated with KYNAR/PMMA 80:20 (10 wt-% solution in MEK) at 80° C. Comparison of Samples 1-3 in Table 21 demonstrate that a short dip time gave as good stain resistance results as 30 sec and 60 sec dip time. Comparison of Samples 1, 4, and 5 showed that stain resistance with single coating was as good as double coating. Excessively long dip time (Sample 6) did not help stain resistance and gave slightly worse results. Comparison of Samples 6 and 7 showed that curing is preferred for this particular composition.

TABLE 22
Stain repellency testing results on ligatures
coated with three different KYNAR
copolymers and their blends with PMMA

| | Fluoropolymer | | Cure | Regular | 300% |
|---|---|---|---|---|---|
| | (in MEK) | Dip time | conditions | Stain | Stain |
| Substrate | (7.5 wt-%) | (sec) | (° C./min) | Test | Test |
| Easy-To-Tie | KYNAR 7201 | Quick dip | 140/15 | No | Light |
| ligature | | | | | |
| Easy-To-Tie | KYNAR Super | Quick dip | 140/15 | No | Very |
| ligature | Flex 2501 | | | | Light |
| | KYNAR FLEX | Quick dip | 140/15 | No | Very |
| | 2751 | | | | Light |
| Easy-To-Tie | 8:2 KYNAR | Quick dip | 140/15 | No | Very |
| ligature | 7201/PMMA | | | | Light |
| Easy-To-Tie | 8:2 KYNAR | Quick dip | 140/15 | No | No |
| ligature | Super Flex | | | | |
| | 2501/PMMA | | | | |
| | 8:2 KYNAR | Quick dip | 140/15 | No | No |
| | Flex | | | | |
| | 2751/PMMA | | | | |

In addition to KYNAR 7201, Easy-To-Tie ligatures were also dip coated with KYNAR Super Flex 2501, KYNAR Flex 2751, 8:2 KYNAR Super Flex 2501: PMMA, and 8:2 Kynar Flex 2751: PMMA, all at 7.5 wt-% concentration in MEK (Table 22). The stain test results indicated that like KYNAR 7201 (VDF/TFE copolymer), KYNAR Super Flex 2501 and KYNAR Flex 2751 (both VDF/HFP copolymer), and their blends with PMMA (8:2 KYNAR: PMMA) also provided stain resistance.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A dental article comprising an elastomeric substrate having disposed thereon at least one layer comprising a fluoropolymer derived from at least one monomer selected from the group consisting of vinylidine fluoride, vinyl fluoride, hexafluoropropylene, tetrafluoroethylene, hexafluoropropylene oxide, a perfluoroalkylvinyl ether, and combinations thereof.

2. The dental article of claim 1 wherein the fluoropolymer comprises interpolymerized units derived from vinylidene fluoride.

3. The dental article of claim 2 wherein the fluoropolymer comprises at least 3 wt-% interpolymerized units derived from vinylidene fluoride.

4. The dental article of claim 2 wherein the fluoropolymer comprises interpolymerized units derived from vinylidene fluoride and hexafluoropropylene.

5. The dental article of claim 1 wherein the fluoropolymer is a copolymer.

6. The dental article of claim 1 wherein the fluoropolymer is selected from the group consisting of tetrafluoroethylene/hexafluoropropylene/vinylidene fluoride terpolymer, polyvinylidene fluoride, vinylidene fluoride/hexafluoropropylene copolymer, vinylidene fluoride/tetrafluoroethylene copolymer, polytetrafluoroethylene, ethylene/tetrafluoroethylene copolymer, tetrafluoroethylene/hexafluoropropylene copolymer, propylene/tetrafluoroethylene copolymer, ethylene/tetrafluoroethylene/hexafluoropropylene terpolymer, and mixtures thereof.

7. The dental article of claim 6 wherein the fluoropolymer is selected from the group consisting of tetrafluoroethylene/hexafluoropropylene/vinylidene fluoride terpolymer, polyvinylidene fluoride, vinylidene fluoride/hexafluoropropylene copolymer, vinylidene fluoride/tetrafluoroethylene copolymer, polytetrafluoroethylene, ethylene/tetrafluoroethylene copolymer, tetrafluoroethylene/hexafluoropropylene copolymer, and mixtures thereof.

8. The dental article of claim 1 wherein the fluoropolymer has a molecular weight of at least 10,000 grams/mole.

9. The dental article of claim 1 which is an orthodontic appliance.

10. The dental article of claim 9 which is an orthodontic force module.

11. The dental article of claim 10 wherein the force module is a ligature, a chain, or a dogbone-shaped force module.

12. The dental article of claim 1 wherein the fluoropolymer comprises a partially fluorinated polymer.

13. The dental article of claim 1 wherein the fluoropolymer is a perfluoropolymer.

14. The dental article of claim 1 wherein the fluoropolymer-containing layer further comprises a nonfluorinated polymer.

15. The dental article of claim 14 wherein the nonfluorinated polymer is selected from the group consisting of acrylic polymers, urethane polymers, vinyl acetate copolymers, and combinations thereof.

16. The dental article of claim 14 wherein the nonfluorinated polymer is the same as the polymer of the elastomeric substrate.

17. The dental article of claim 1 wherein the elastomeric substrate comprises a polyurethane, nitrile rubber, ethylene propylene diene rubber, styrenic block copolymers (e.g., styrene-butadiene-styrene, styrene-ethylene/butadiene-styrene and styrene-isoprene) or combinations thereof.

18. The dental article of claim 1 wherein the elastomeric substrate comprises a polyester-based urethane or a polyether-based urethane.

19. The dental article of claim 18 wherein the elastomeric substrate comprises poly(ethyleneadipate)urethane.

20. The dental article of claim 1 wherein the fluoropolymer comprises at least 30 wt-% fluorine atoms.

21. The dental article of claim 1 wherein at least 50% of the fluorine atoms present in the fluoropolymer are in the backbone of the fluoropolymer.

22. The dental article of claim 21 wherein substantially all the fluorine atoms present are in the backbone of the fluoropolymer.

23. The dental article of claim 1 wherein the fluoropolymer includes less than 5 wt-% silicon atoms.

24. The dental article of claim 23 wherein the fluoropolymer includes less than 3 wt-% silicon atoms.

25. The dental article of claim 1 wherein the substrate is primed with poly-1-lysine or polyallylamine.

26. The dental article of claim 1 wherein the fluoropolymer-containing layer has a peel strength from a polyurethane-containing film of greater than 0.4 N/cm.

27. The dental article of claim 1 wherein the change in color after 24 hour mustard stain test has a ΔE of less than 30.

28. The dental article of claim 1 wherein the fluoropolymer-containing layer comprises a mixture of two or more fluoropolymers.

29. A dental article comprising an elastomeric substrate having disposed thereon at least one layer comprising a fluoropolymer having at least 30 wt-% fluorine.

30. The dental article of claim 29 wherein the fluoropolymer comprises interpolymerized units derived from vinylidene fluoride, vinyl fluoride, hexafluoropropylene, tetrafluoroethylene, hexafluoropropylene oxide, a perfluoroalkylvinyl ether, and combinations thereof.

31. The dental article of claim 30 wherein the fluoropolymer is selected from the group consisting of tetrafluoroethylene/hexafluoropropylene/vinylidene fluoride terpolymer, polyvinylidene fluoride, vinylidene fluoride/hexafluoropropylene copolymer, vinylidene fluoride/tetrafluoroethylene copolymer, polytetrafluoroethylene, ethylene/tetrafluoroethylene copolymer, tetrafluoroethylene/hexafluoropropylene copolymer, propylene/tetrafluoroethylene copolymer, ethylene/tetrafluoroethylene/hexafluoropropylene terpolymer, and mixtures thereof.

32. The dental article of claim 31 wherein the fluoropolymer is selected from the group consisting of tetrafluoroethylene/hexafluoropropylene/vinylidene fluoride terpolymer, polyvinylidene fluoride, vinylidene fluoride/hexafluoropropylene copolymer, vinylidene fluoride/tetrafluoroethylene copolymer, polytetrafluoroethylene, ethylene/tetrafluoroethylene copolymer, tetrafluoroethylene/hexafluoropropylene copolymer, and mixtures thereof.

33. The dental article of claim 29 wherein the fluoropolymer is a perfluoropolyether.

34. The dental article of claim 29 wherein the fluoropolymer is vinylidene fluoride/tetrafluoroethylene copolymer or vinylidene fluoride/hexafluoropropylene copolymer.

35. The dental article of claim 29 which is an orthodontic appliance.

36. The dental article of claim 35 which is an orthodontic force module.

37. The dental article of claim 35 wherein the force module is a ligature, chain, or dogbone-shaped force module.

38. The dental article of claim 29 wherein the fluoropolymer comprises a partially fluorinated polymer.

39. The dental article of claim 29 wherein the fluoropolymer is a perfluoropolymer.

40. The dental article of claim 29 wherein the fluoropolymer-containing layer further comprises a nonfluorinated polymer.

41. The dental article of claim 40 wherein the nonfluorinated polymer is selected from the group consisting of acrylic polymers, urethane polymers, vinyl acetate copolymers, and combinations thereof.

42. The dental article of claim 40 wherein the nonfluorinated polymer is the same as the polymer of the elastomeric substrate.

43. The dental article of claim 29 wherein at least 50% of the fluorine atoms present in the fluoropolymer are in the backbone of the fluoropolymer.

44. The dental article of claim 29 wherein the fluoropolymer comprises at least 50 wt-% fluorine atoms.

45. The dental article of claim 29 wherein the fluoropolymer includes less than 5 wt-% silicon atoms.

46. The dental article of claim 29 wherein the substrate is primed with poly-l-lysine or polyallylamine.

47. The dental article of claim 29 wherein the fluoropolymer-containing layer comprises a mixture of two or more fluoropolymers.

48. A method of reducing adhesion of a substance to a dental article, wherein the method comprises:
providing a dental article comprising an elastomeric substrate; and
depositing at least one layer comprising a fluoropolymer to at least a portion of the elastomeric substrate;
wherein the fluoropolymer is derived from at least one monomer selected from the group consisting of vinylidine fluoride, vinyl fluoride, hexafluoropropylene, tetrafluoroethylene, hexafluoropropylene oxide, a perfluoroalkylvinyl ether, and combinations thereof.

49. The method of claim 48 wherein depositing at least one layer comprises applying a coating composition comprising a liquid carrier and the fluoropolymer to the elastomeric substrate.

50. The method of claim 49 wherein the liquid carrier is an organic solvent.

51. The method of claim 49 wherein the coating composition is a solution.

52. The method of claim 48 wherein the coating composition comprises 1 wt-% to 20 wt-% of the fluoropolymer.

53. The method of claim 48 wherein depositing at least one layer comprises dipping the elastomeric substrate in a coating composition comprising the fluoropolymer.

54. The method of claim 53 further comprising thermally curing the applied coating composition.

55. The method of claim 48 wherein the fluoropolymer comprises at least 30 wt-% fluorine.

56. The method of claim 48 wherein at least 50% of the fluorine atoms present in the fluoropolymer are in the backbone of the fluoropolymer.

57. The method of claim 48 wherein the fluoropolymer includes less than 5 wt-% silicon atoms.

58. The method of claim 48 wherein the fluoropolymer comprises interpolymerized units derived from vinylidene fluoride, vinyl fluoride, hexafluoropropylene, tetrafluoroethylene, hexafluoropropylene oxide, a perfluoroalkylvinylether, and combinations thereof.

59. The method of claim 58 wherein the fluoropolymer is selected from the group consisting of tetrafluoroethylene/hexafluoropropylene/vinylidene fluoride terpolymer, polyvinylidene fluoride, vinylidene fluoride/hexafluoropropylene copolymer, vinylidene fluoride/tetrafluoroethylene copolymer, polytetrafluoroethylene, ethylene/tetrafluoroethylene copolymer, tetrafluoroethylene/hexafluoropropylene copolymer, and mixtures thereof.

60. A method of reducing adhesion of a substance to a dental article, wherein the method comprises:
providing a dental article comprising an elastomeric substrate; and
depositing at least one layer comprising a fluoropolymer to at least a portion of the elastomeric substrate;
wherein the fluoropolymer comprises at least 30 wt-% fluorine.

61. The method of claim 60 wherein the fluoropolymer is derived from at least one monomer selected from the group consisting of vinylidine fluoride, vinyl fluoride, hexafluoropropylene, tetrafluoroethylene, hexafluoropropylene oxide, a perfluoroalkylvinyl ether, and combinations thereof.

62. The method of claim 61 wherein the fluoropolymer is selected from the group consisting of tetrafluoroethylene/hexafluoropropylene/vinylidene fluoride terpolymer, polyvinylidene fluoride, vinylidene fluoride/hexafluoropropylene copolymer, vinylidene fluoride/tetrafluoroethylene copolymer, polytetrafluoroethylene, ethylene/tetrafluoroethylene copolymer, tetrafluoroethylene/hexafluoropropylene copolymer, and mixtures thereof.

63. An elastomeric substrate comprising an organic polymeric material having disposed thereon at least one layer comprising a fluoropolymer, wherein the fluoropolymer is prepared from a halogen-containing fluoropolymer and a peroxide curing system comprising an organic peroxide initiator and a multifunctional aliphatic unsaturated compound.
